(19) United States
(12) Patent Application Publication
(10) Pub. No.: US 2011/0070537 A1
(43) Pub. Date: Mar. 24, 2011

(54) ELECTROPHOTOGRAPHIC PHOTORECEPTOR

(75) Inventors: Tadaaki SUMITANI, Tokyo (JP); Nobuaki KOBAYASHI, Tokyo (JP)

(73) Assignee: KONICA MINOLTA BUSINESS TECHNOLOGIES, INC., Tokyo (JP)

(21) Appl. No.: 12/883,256

(22) Filed: Sep. 16, 2010

(30) Foreign Application Priority Data
Sep. 24, 2009 (JP) 2009218582

(51) Int. Cl. G03G 15/00

(52) U.S. Cl. 430/56; 399/159

(57) ABSTRACT

An image forming method employing a photoreceptor and a polymerization toner, wherein the photoreceptor comprises a photosensitive layer provided on a surface of a cylindrical electroconductive substrate, a surface of the photoreceptor has a shape composed of plural lower portions and plural higher portions, a surface roughness of a top surface of the higher portions is 0.01 to 0.5 μm, and a volume based median particle diameter of the polymerization toner is 3 to 8 μm.

This application is a base tabled on Japanese Patent Application No. 2009-0218582 filed on Sep. 24, 2009, in Japanese Patent Office, the entire content of which is hereby incorporated by reference.

### FIELD OF THE INVENTION

The present invention relates to an image forming method by employing electrophotographic photoreceptor used for electrophotographic image forming apparatus, such as a copier, a laser beam printer or a facsimile.

### BACKGROUND OF THE INVENTION

Recently, image processing machines using an electrophotographic image forming apparatus by an electrophotographic image forming process have made remarkable development. An electrophotographic image forming apparatus is one which forms images on a recording medium (for example, recording paper, OHP sheet or the like) by a process of electrophotographic image formation. Examples of such an electrophotographic image forming apparatus include an electrophotographic copying machine, an electrophotographic printer (for example, laser printer, LED printer or the like), a facsimile apparatus, a word processor and their combinations (multi-function printer or the like).

Recently, image processing machines using an electrophotographic image forming apparatus by an electrophotographic image forming process have made remarkable development. An electrophotographic image forming apparatus is one which forms images on a recording medium (for example, recording paper, OHP sheet or the like) by a process of electrophotographic image formation. Examples of such an electrophotographic image forming apparatus include an electrophotographic copying machine, an electrophotographic printer (for example, laser printer, LED printer or the like), a facsimile apparatus, a word processor and their combinations (multi-function printer or the like).

In the past, there were used inorganic photoreceptors employing inorganic compounds such as a selenium compound as a photoreceptor used in a laser printer or a digital copying machine of an electrophotographic image forming apparatus. Recently, there have been used organic photoreceptors employing organic compounds which make it easy to develop materials responsive to light of various wavelengths and also have little impact on the environments.

In an electrophotographic image forming apparatus by a process of electrophotographic image formation (hereinafter, also designated simply as an image forming apparatus), the outer circumferential surface of a photosensitive layer of a drum-form electrophotographic photoreceptor (hereinafter, also designated as simply as photoreceptor) which has been uniformly electrostatic-charged, is selectively exposes a base tabled on image data to form an electrostatic latent image thereon. The thus formed electrostatic latent image is developed with a toner (developer) by a developing means to form a toner image. Then the toner image is transferred to a recording medium to form then image. Further, after having transferred the toner image, a developer or the like remaining on the outer circumferential surface of the photosensitive layer of the photoreceptor is removed by a cleaning means. The photoreceptor, the outer circumferential surface of which has been cleaned by a cleaning means, is subjected to the next image formation process. Thus, in the outer circumferential surface of a photosensitive layer of a photoreceptor used for image formation in an image forming apparatus, image formation is performed through a series of repeated steps of electrostatic-charging, exposure, development, transfer and cleaning.

In an image forming apparatus by a process of electrophotographic image formation, there has been studied reduction of friction coefficient of the photosensitive layer surface of a photoreceptor with the aim of reducing the remaining toner amount after transfer as well as prevention of adhesion of an unwanted toner. It is known that this renders it difficult to cause cleaning trouble when cleaning a toner remaining on the photosensitive layer without being transferred by a blade or a brush. There are also known environmental effects such that a residual toner amount after transfer is reduced, leading to reduction of the waste toner amount, reduced torque to drive a photoreceptor and reduced electric power consumption of the image forming apparatus.

There is generally known a method of cleaning a residual toner on a photosensitive layer after transfer by a blade formed of urethane rubber or the like, which is brought into contact in the counter direction.

Meanwhile, development of a polymerization toner produced through emulsion polymerization, suspension polymerization or the like has been advanced along with recent demand for higher image quality in the market. However, such a polymerization toner easily causes cleaning trouble, as compared to irregular-shaped toner particles, resulting in image deterioration due to toner filming or fusion and leading to demand for further precise cleaning. The outer surface of a photosensitive layer and a blade, both of which are made of a resin, are insufficient in lubrication, and a blade easily reverses on the smooth surface of the photosensitive layer, often causing cleaning trouble.

To resolve problems of cleaning trouble, there is known addition of a lubricant to the photosensitive layer surface to reduce friction coefficient. Examples of a lubricant include a fluorine-containing resin (hereinafter, also designated as a fluororesin) such as polytetrafluoroethylene, a spherical acryl resin, a powdery polyethylene, a powdery metal oxide such as silicon oxide or aluminum oxide, and a lubricant liquid such as silicone oil. Specifically, a fluororesin containing a relatively large amount of fluorine atoms exhibits a markedly reduced surface energy and results in enhanced lubricating effects. However, reduction of friction coefficient by these methods often produces problems such that contact with a blade over a long period of time results in a gradual increase of friction coefficient, leading to increased friction with the blade and causing troubles such as abnormal noise of the blade, torsion or the like.

A photoreceptor having a shape composed of higher portions and lower portions on a surface of the photoreceptor is studied otherwise. For example disclosed is a technique, in which a photoreceptor has a plural of independent lower portions on the surface of the photoreceptor, wherein a distance between the walls of neighboring lower portions is not more than 10 μm, depth showing the distance between the bottom and opening surface of the lower portion is not less than 0.1 μm, the number thereof is not less than 10 per 100 μm square of the surface contacting to a charging member, and a toner containing inorganic microparticles having primary average particle size of 30 to 500 nm is used in combination (See, JP-A 2008-268433).

A photoreceptor having a specific the shape composed of higher portions and lower portions formed by polymerization of the polymerizable monomer on the cylindrical substrate is disclosed, which is manufactured by steps comprising a surface layer coating step in which surface layer coating composition containing polymerizable material is coated on a cylindrical substrate, a shape forming step in which the shape composed of higher portions and lower portions is formed on the coated surface of the surface layer coating composition, a polymerization step in which the polymerizable material is polymerized (See, JP-A 2009-25710).

It is effective in improvement of cleaning performance, reducing abnormal noise and torsion of the blade or the like, by virtue of reducing the contact area of the blade by forming the shape composed of higher portions and lower portions on the surface of the photoreceptor by employing the techniques described in the above described documents, however it has been found the following problems.

1. Since an angle formed between wall and top surface of the higher portions is right angle and by its result, charge distribution on the surface of the photoreceptor becomes non-uniform, charge is apt to be concentrated at the end of the top surface when the charge is applied to the photoreceptor.

2. Slipping performance between a top surface of the higher portions and the blade is not sufficient, and generation of blade torsion is not sufficiently prevented.

3. When small diameter toner having volume based median particle diameter of 3 to 8 μm is used, sufficient image quality satisfying the request for high image quality by market is not obtained, since toner particles put into the lower portions are not sufficiently cleaned, whereby filming generates and toner particles remaining on the surface of the photoreceptor is fused and charge distribution at the surface of the photoreceptor is not uniform.

In these circumstances it is desired to develop a photoreceptor having the shape composed of higher portions and lower portions on its surface which has characteristics that charge distribution is uniform when charge is applied, and has blade slipping performance to ensure high speed image forming and excellent cleaning performance when a small particle size toner is used to obtain high quality images constantly.

### SUMMARY OF THE INVENTION

The object of the invention is to provide an image forming method employing a photoreceptor having a shape composed of higher portions and lower portions on its surface as well as a polymerization toner. The photoreceptor has characteristics that charge distribution is uniform when charge is applied, and has blade slipping performance to ensure high speed image forming and an excellent cleaning performance when a small particle size toner is used so as to obtain high quality images constantly.

The embodiment of the invention is described. An image forming method comprising steps of forming latent image on a photoreceptor, developing the latent image by a developer containing a polymerization toner, wherein the photoreceptor comprises a photosensitive layer provided on a surface of a cylindrical electroconductive substrate, a surface of the photoreceptor has a shape composed of plural lower portions and plural higher portions, a surface roughness of a top surface of the higher portions is 0.01 to 0.5 μm, and a volume based median particle diameter of the polymerization toner is 3 to 8 μm.

Height M of the higher portions from the bottom of the lower portions is preferably that satisfies the relation ( 1/10)D≦M≦(⅓)D, wherein D is the volume based median particle diameter of the polymerization toner.

Density of the higher portions is preferably 1 to 5,000 per 10 μm square.

### BRIEF DESCRIPTION OF THE DRAWINGS

FIGS. 1a-1c illustrate a constitution of an image forming section of an electrophotographic image forming apparatus.

FIGS. 2a and 2b illustrate model view of the photoreceptor having a shape composed of plural lower portions and plural higher portions on the surface.

FIG. 3a is a sectional view illustrating plural lower portions and plural higher portions.

FIG. 3b is a sectional view illustrating a higher portion.

FIGS. 4a 4b illustrate schematic views of an abrading apparatus to abrade the surface of a photosensitive layer of a photoreceptor.

FIGS. 5a-5c illustrate enlarged schematic views showing the shape of the abrading surface of an abrading tape used the abrading apparatus shown in FIGS. 2a-2b.

FIGS. 6a-6e illustrate enlarged schematic views showing other shapes of the abrading surface of an abrading tape used the abrading apparatus shown in FIGS. 2a-2b.

FIGS. 7a and 7b show a schematic view of an apparatus forming a shape composed of plural lower portions and plural higher portions on the surface of the photoreceptor.

FIG. 8 illustrates an outlined flow chart showing manufacturing method of the photoreceptor having a shape composed of plural lower portions and plural higher portions by pattering via intermittent exposure method after abrading the photoreceptor surface.

FIG. 9 illustrates an outlined flow chart showing manufacturing method of the photoreceptor by abrading the photoreceptor surface after forming a shape composed of plural lower portions and plural higher portions by pattering via intermittent exposure method.

FIG. 10 illustrates an outlined flow chart showing manufacturing method of the photoreceptor having a shape composed of plural lower portions and plural higher portions by pattering via continuous exposure method after abrading the photoreceptor surface.

### DETAILED DESCRIPTION OF THE INVENTION

The photoreceptor used in the present invention has characteristics that charge distribution is uniform when charge is applied, and has blade slipping performance to ensure high speed image forming and an excellent cleaning performance when a small particle size toner is used so as to obtain high quality images constantly. The surface of the photoreceptor includes a protective layer formed on a photosensitive layer.

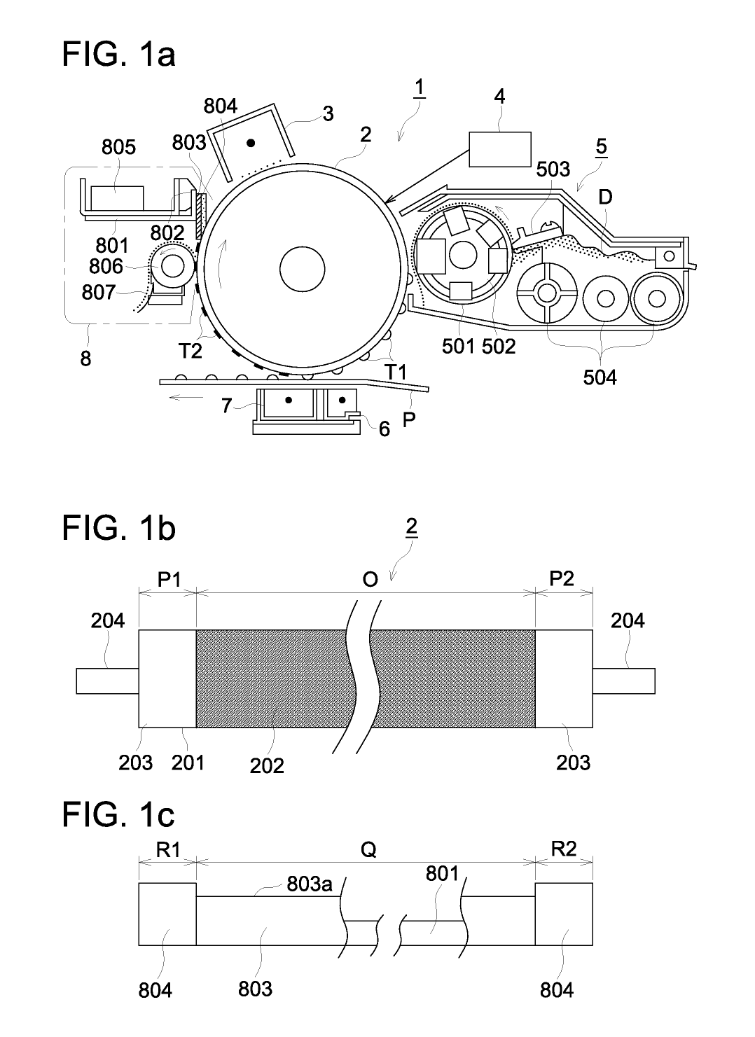

The invention will be further detailed with reference to FIGS. 1-10.

FIGS. 1a to 1c illustrate a constitution of an image forming section of an electrophotographic image forming apparatus. FIG. 1a is a schematic sectional view showing an image forming section of an electrophotographic image forming apparatus. FIG. 1b is a schematic plan view of a photoreceptor. FIG. 1c is a schematic plan view of a cleaning blade and a sealing member installed in a frame body of a cleaning device, as shown in FIG. 1a.

In the FIGS, numeral 1 designates an image forming section. In the image forming section 1 are disposed a photoreceptor 2, an charger 3 providing electrostatic charge, an imagewise-exposure device 4, a developing device 5, a charger 6 as a transfer means to transfer the toner image formed on the circumference surface of the photoreceptor 2 to recording paper from the photoreceptor 2, a charge neutralizer 7 to remove an electric charge on recording paper and separate the recording paper from the photoreceptor 2 and a cleaning device 8 as a cleaning means.

The photoreceptor 2 is provided with a photosensitive layer on a cylindrical substrate formed of an electrically conductive substrate such as aluminum, is rotatably placed in the image forming apparatus and is rotated clockwise via driving source (not shown in the drawing), as indicated by the arrow.

The developing device 5 houses a developer D composed of a toner and a carrier, and comprising a development sleeve 501 conveying a developer through rotation in the direction designated by the arrow, a fixed magnet 502 to form ears of the developer to be used for development, a control member to control the amount of the conveyed developer and a developer stirring member 504 to charge a toner mixed with a carrier.

The photoreceptor 2 is uniformly charged by the charger 3 through rotation of the photoreceptor 2 in the direction, as indicated by the arrow and imagewise exposed by the exposure device 4 to form an electrostatic latent image on the photoreceptor 2. The thus formed electrostatic latent image is developed by the developing device 5 to form a toner image T1 on the photoreceptor 2. The formed toner image T1 is transferred onto recording paper P by an electrostatic force produced by charging of the charger 6. Recording paper P is separated from the photoreceptor 2 by the charge neutralizer 7 and conveyed to a fixing device (not shown in the drawing) to be fixed.

A toner T2 remains on the photoreceptor 2 after transfer, but the thus remaining toner T2 is removed from the photoreceptor 2 by the cleaning device 8.

In the interior of the cleaning device 8, a supporting frame body 801 as a backing member which is long in the rotational axis direction is disposed parallel to the rotational axis of the photoreceptor 2 and is free-rotatably substrate by a shaft 802 at both ends in the direction of the rotational axis of the photoreceptor 2. The supporting frame body 801 is fixed by adhering a cleaning blade formed of an elastic plate constituted of urethane rubber to clean the photoreceptor 2 located at its bottom portion. The supporting frame body 801 is provided with a sealing member 804 at both ends of the cleaning blade 803 to prevent leakage of toner from both ends of the cleaning blade 803. Further, a weight 805 as a means to bring into contact is provided at the other end of the supporting frame body 801 to bring the cleaning edge at the top of the cleaning blade 803 against the photoreceptor 2 at a given contact pressure.

A toner receiving roller 806, which is lightly contacted with the photoreceptor 2 and rotates so that its top face moves in the same direction as the photoreceptor 2, is disposed upstream the cleaning blade 803 (in the rotational direction of the photoreceptor 2). A scraper plate 807 is in contact with the toner receiving roller 806 to scrape any toner from the toner receiving roller 806.

A cleaning blade usually employs rubber elastomer and examples of such a material include urethane rubber, silicone rubber, fluorinated rubber, chloroprene rubber, butadiene rubber and the like. Of these, urethane rubber, which superior in abrasion characteristic to other rubbers, is specifically preferable.

Toner T2 which remains on the photoreceptor 2 after transfer is removed by the cleaning blade 803 is removed by the cleaning blade 803 from the photoreceptor 2, conveyed by the toner receiving roller 806 and the scraper plate 807 to the bottom portion and further conveyed by a toner conveying means (not shown in the drawing) to the outside of the cleaning device 8.

The photoreceptor 2 is constituted of a cylindrical conductive substrate 201, a photosensitive layer 202 formed on the circumference surface of the conductive substrate 201, a non-photosensitive layer forming portion 203 on both ends of the conductive substrate 201 and a mounting shaft 204 of an electrophotographic image forming apparatus at each end of the photoreceptor.

A forming area of the photosensitive layer 202 may be formed on the overall width of the conductive substrate 201 or may be formed with leaving a non-photosensitive layer forming portion 203 at each end of the conductive substrate 201.

Designation “O” indicates the width of the photosensitive layer in the longitudinal axis direction of the photoreceptor 2 and also indicates the image forming area in which the toner image T1 is formed by development in the developing device 5. The toner image T1 is formed in the image forming area, which is also the area of any remaining toner T2 existing after having transferred the image to recording paper P.

Polymerization toner is used in this invention. The volume based median particle diameter of the polymerization toner is 3 to 8 μm. When the volume based median particle diameter of the polymerization toner is not more than 3 μm, insufficient cleaning performance affects image quality.

When the volume based median particle diameter of the polymerization toner is more than 8 μm, it is not preferable for high quality image because of poor fine line reproduction.

The particle diameter at a 50% point from the higher side of the volume accumulation ratio (namely the volume D₅₀% diameter) is designated as the volume-based median diameter. The volume based median diameter is determined using “Coulter Multisizer III” (produced by Beckman Coulter, Inc.).

As to the toner particle of the present invention, the average circularity of toner particles which is represented by the following formula is preferably 0.930 to 1.000, and more preferably 0.950 to 0.995.

The average circularity of toner particles refers to a value determined using “FPIA-2100” (produced by Sysmex Corp.). Specifically, the toner is wetted with an aqueous solution containing a surfactant, followed by being dispersed via ultrasonic dispersion treatment for 1 minute, and thereafter the dispersion of the toner particles is photographed with “FPIA-2100” (produced by Sysmex Corp.) in a measurement condition HPF (high magnitude photographing) mode at an appropriate density of a HPF detection number of 3,000-10,000. The circularity of each of the toner particles is calculated according to Equation (y) described below. Then, the average circularity is calculated by totaling the circularities of the individual toner particles and by dividing the resultant value by the total number of the toner particles.

Circularity=((circumference of a circle having the same projective area as a particle image)/(circumference of the projective area of the particle)

The polymerization toner is prepared via a process of forming resin particles during the polymerization of polymerizable monomers, preferably, in an aqueous medium.

The polymerization toner used in the invention can be obtained by a manufacturing methods described in, for example, JP-A 2004-138874 and JP-A 2003-345063.

P1 designates the width of the non-photosensitive layer forming portion 203 in the axis direction of the photoreceptor at one end of the conductive substrate 201. P2 designates the width of the non-photosensitive layer forming portion 203 at the other end of the conductive substrate 201. The width P1 (or P2) of the non-photosensitive layer forming portion 203 is preferably from 0.5 mm to 20 mm, taking into account prevention of peeling of a photosensitive layer due to contact with a positioning member when installed on an image forming apparatus.

The cleaning blade 803 is mounted on the supporting frame body 801 of the cleaning device 8 so that an edge 803a of the cleaning blade 803 is pressed to contact with the overall width “O” of the photosensitive layer 202, enabling it to remove any remaining toner existing on the image forming area, A width (Q) of the cleaning blade 803 is preferably the same as or a little larger than that of the photosensitive layer 202 of the photoreceptor 2.

The sealing member 804 is fixed onto the supporting frame body 801 separately from the cleaning blade 803 to be in contact with the non-photosensitive layer forming portion 203 at each end of the photoreceptor 2. Preferably, the width R1 (or R2) of the sealing member 804 is so wide that an end on the cleaning blade (803) side of the sealing member 804 is in contact with the end of the cleaning blade 803 and is the same as a width P1 (or P2) of the non-photosensitive layer forming portion 203. When removing any toner remaining in an image area by the cleaning blade 803, providing the sealing member 404 at each end of the cleaning blade 803 enables it to prevent leakage of any remaining toner from each end of the cleaning blade 803.

The sealing member is not specifically limited but examples thereof include one in which a porous elastic member, (e.g., MOLTPLAIN (trade name), felt, napped cloth and the like) adhered onto an elastic substrate (e.g., polyethylene terephthalate or PET).

The photoreceptor 2 is provided with at least a photosensitive layer on a conductive substrate and the layer arrangement is not specifically limited. Specific examples of a latter arrangement are as follows:

1) A layer arrangement of a conductive substrate provided thereon with a charge generation layer, a charge transport layer and a protective layer in the said sequence;

2) A layer arrangement of a conductive substrate provided thereon with a single layer containing a charge generation material and a charge transport material and a protective layer in the said sequence;

3) A layer arrangement of a conductive substrate provided thereon with an intermediate layer, a photosensitive layer of a charge generation layer and a charge transport layer and a protective layer in the said sequence;

4) A layer arrangement of a conductive substrate provided thereon with an intermediate layer, a photosensitive layer containing a charge generation material and a charge transport material, and a protective layer in the said sequence.

The photoreceptor of the invention may be any one of the foregoing layer arrangement, and of these is preferred a layer arrangement of a conductive substrate provided with an intermediate layer, a charge generation layer, a charge transport layer, and a protective layer.

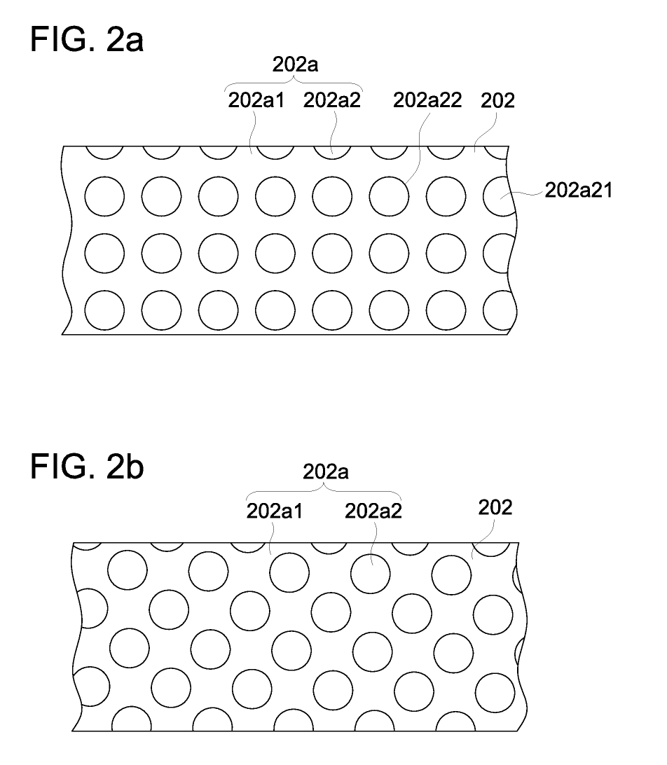

FIGS. 2a and 2b are outlined enlarged part of the photoreceptor. These illustrate typical shape composed of plural lower portions and plural higher portions formed on the photosensitive layer 202.

Symbol 202a designates a shape composed of plural lower portions and plural higher portions formed on the photosensitive layer 202. In the figure, 202a1 and 202a2 show the higher portion and lower portion, respectively. The shape 202a is composed of lower portion 202a1 and higher portion 202a2.

The outlined enlarged part of the photoreceptor shown FIG. 2a is described.

This figure designates the photoreceptor wherein lower portions 202a1 and higher portions 202a2 composing the shape composed of higher portions and lower portions 202a are disposed at parallel with reference to a rotation axis of the photoreceptor. The symbol 202a21 designates a top surface of a higher portion 202a2, and 202a22 designates an end of a top surface 202a21 of the higher portion 202a2.

The outlined enlarged part of the photoreceptor shown FIG. 2b is described.

This figure designates the photoreceptor wherein lower portions 202a1 and higher portions 202a2 composing the shape composed of higher portions and lower portions 202a are disposed on a slant with reference to a rotation axis of the photoreceptor.

It is preferable that the shape composed of higher portions and lower portions 202a has uniform pattern taking into count of the uniform charge distribution when charge is applied to the photoreceptor, uniform pressure of blade to the photoreceptor, and cleaning performance.

The term of uniform pattern means that a pattern in which number of the higher portions 202a2 in unit area on the surface of the photoreceptor is the same.

Density of the higher portions 202a2 is preferably 1 to 5,000 per 10 μm square taking account of slipping performance of the blade, torsion of the blade or the like,

The density can be determined by observation via laser microscope VK-9510 manufactured by KEYENCE Corp.

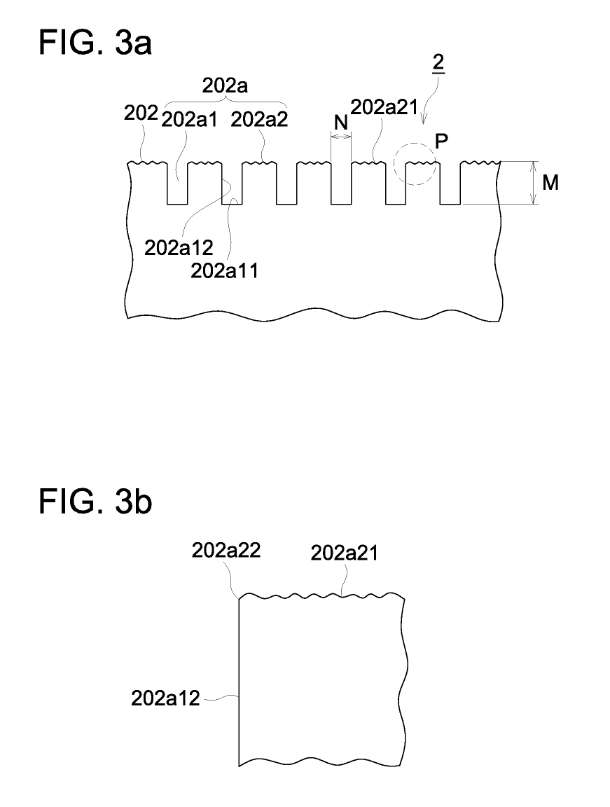

FIGS. 3a and 3b show a sectional view of outlined enlarged photoreceptor. FIG. 3a is sectional view of outlined enlarged photoreceptor along with the rotation axis. FIG. 3b is an enlarged sectional view of the portion P in FIG. 3a.

In the figure, 202a designates the shape composed of higher portions and lower portions formed on the surface of the photosensitive layer 202 of the photoreceptor 2. The shape 202a is composed of lower portions 202a1 and higher portions 202a2. Symbol 202a11 designates bottom of lower portions 202a1, 202a12 designates a will of lower portions 202a1, and 202a21 designates top surface of higher portions 202a2.

An angle formed between wall 202a12 and top surface 202a21 at the end 202a22 of the top surface 202a21 is preferably obtuse angle. When this is obtuse angle, charge is difficult to concentrate to the end 202a22 of the top surface 202a21 when charge is applied to the photoreceptor, and uniform charge distribution is formed on the photoreceptor surface. Consequently, generation of uneven image is prevented and high quality is obtained.

Shape of the higher portion 202a2 is not particularly restricted and includes, circular column and square column.

Area of the higher portion 202a2 at the bottom is preferably 0.008 to 90 μm², and more preferably 0.01 to 50 μm², taking into account of blade adhesion, cleaning performance or the like.

Symbol M designates a height from bottom 202a11 to top surface 202a21. The height M is a height of higher portions 202a2. M also means a depth of lower portions.

Height M is preferably satisfies the relation ( 1/10)D≦M≦(⅓)D, taking into account of cleaning performance, toner clogging and the like, wherein D is the volume based median particle diameter of the polymerization toner. The volume based median diameter of the polymerization toner used in the invention is 3 to 8 μm. Height M is practically 0.6 to 2.5 μm and more preferably 0.8 to 2.2 μm.

Height M indicates a value determined by observation using a laser microscope (VK-9510, made by KEYENCE Corp.).

Symbol N designates a distance between the neighboring higher portions. Distance N is preferably 4 to 7 μm taking into account of toner clogging, cleaning performance and the like, and the distance N is narrower than the volume based median particle diameter of the polymerization toner.

Surface roughness Rz of top surface 202a21 is 0.01 to 0.5 μm, and more preferably 0.1 to 0.3 μm.

When it is not more than 0.01 μm, it is not preferable because the surface is too smooth and blade adhesion occurs. Blade adhesion is such a phenomena that torque between the photoreceptor and the blade become higher at the start from shutdown state.

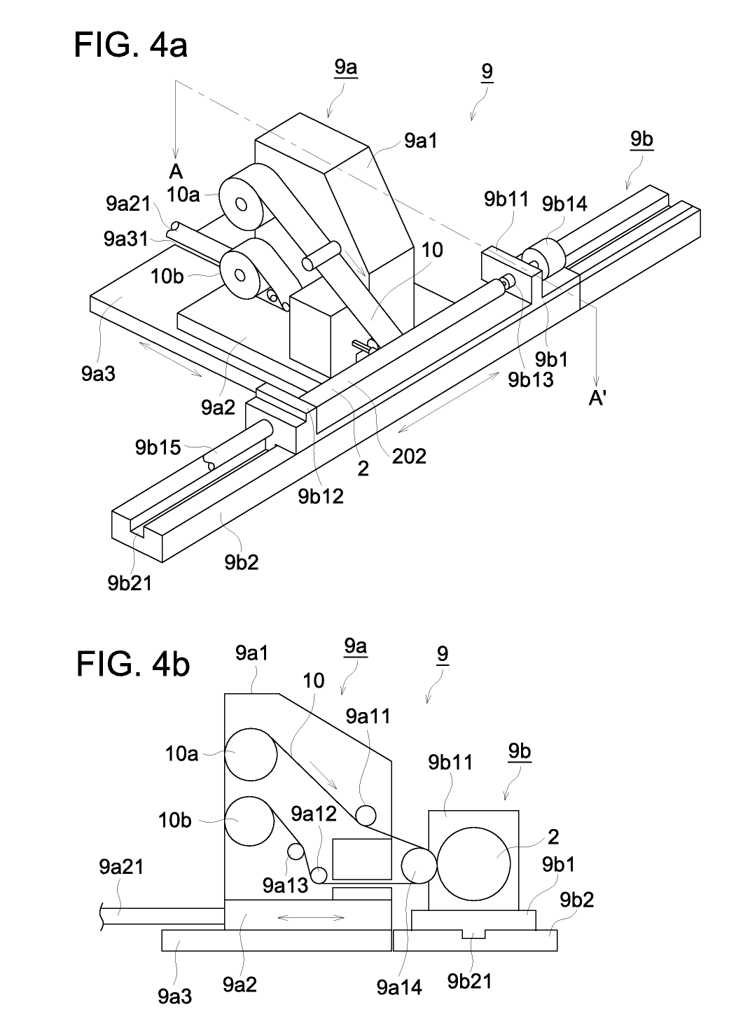

When it is over 0.5 μm, it is not preferable because uneven image is formed due to charge accumulation. Surface roughness Rz indicates a value measured by using a laser microscope (VK-9510, made by KEYENCE Corp.). Methods to roughen top surface 202a21 will be described by means of FIGS. 4 to 6.

The invention relates to a photoreceptor having a the shape composed of higher portions and lower portions by which charge distribution is uniform when charge is applied, and has blade slipping performance to ensure high speed image forming and an excellent cleaning performance when a small particle size toner is used so as to obtain high quality images constantly.

The shape composed of higher portions and lower portions of the photosensitive layer on the surface of the photoreceptor illustrated in FIGS. 2 and 3 can be formed by the following methods.

In the first method the lower portions are formed after roughening the photoreceptor surface. In the second method top surface of the higher portions is roughened after lower portions are formed. These methods can be optionally selected as required. A method to roughen the surface of the photosensitive layer of the photoreceptor is described below.

FIGS. 4a and 4b show a schematic view of an abrading apparatus to abrade the surface of a photosensitive layer of a photoreceptor. FIG. 4a shows a perspective view of an abrading apparatus to abrade the photosensitive layer surface of a photoreceptor. FIG. 4b shows a sectional view along A-A′ of FIG. 4a. FIGS. 4a and 4b show the case of using a belt-form abrasive tape as an abrasive material.

In the drawings, numeral 9 designates an abrading apparatus. The abrading apparatus 9 is provided with an abrasive tape-conveying device 9a and a photoreceptor holding device 9b. The abrasive tape-conveying device 9a comprises a body 9a1, a rack 9a2 and a base table 9a3. The body 9a1 is provided with a device of a feeding device (not shown in the drawing) of an abrasive tape 10, a take-up reel device (not shown in the drawing) and a tension control device (not shown in the drawing) of the abrasive tape 10. A driving section is provided on the side of the reel device. The tension control device is provided on the side of the feeding device.

Numeral 10a designates a roll-formed abrasive tape set in the feeding device (not shown in the drawing). Numeral 10b designates a used abrasive tape reeled by the reel device (not shown in the drawing). Numerals 9a11-9a13 designate guide rolls. The guide rolls 9a11 and 9a13 are preferably disposed in the body 9a1 to control the tension of the abrasive tape 10. Numeral 9a14 designates a backup roll. The abrasive tape 10, fed by the feeding device, is taken up to a roll by the reel device via the backup roll 9a14. When abrading the surface of the photoreceptor 2 at one position of the abrasive tape 10, abrasion or clogging of the abrasive tape surface often renders it difficult to perform stable abrasion, so that it is preferred to feed an abrasive tape from the feeding device as needed and to take up by the reel device to renew the abrasion surface.

The width of the backup roll 9a14 is preferably from 40 to 97% of the width of the photosensitive layer 202, taking into account cutting or the like of the conductive substrate 201 (FIG. 1b) exposed to the non-photosensitive layer-forming portion of the photoreceptor 2.

The hardness of the backup roll 9a14 is preferably from 20 to 40°, taking into account pressure, stability and abrasiveness.

Materials used for a backup roll are not specifically limited so long as the required hardness can be achieved, and include, for example, neoprene rubber, silicone rubber urethane, fluorinated rubber and butadiene; of these, the neoprene rubber and silicone rubber are preferred.

The width of the abrasive tape 10 of an abrasive member is preferably from 101% to 130% of that of the backup roll 9a14, taking into account crease or abrasiveness of an abrasive tape. The width of the abrasive tape refers to the width perpendicular to the conveyance direction of the abrasive tape. The width of the backup roll refers to the width in the axial direction of the drum portion in which the cross-section orthogonal to the center axis of the backup roll has an identical area.

The body 9a1 is fixed to a rack 9a2 having a shaft for moving (9a21) connected to a moving means (for example, a stepping motor), and the rack 9a2 is movable along a traveling channel 9a31 provided on the base table 9a3 (in the direction designated by the arrow or the Y-axis direction).

Movement of the rack 9a2 is adjusted by a moving means so that the surface of the abrasive tape 10 and the surface of the photosensitive layer 202 of the photoreceptor 2 are pressed in parallel with each other, and the pressure at the time of abrading is optimally controlled by the type of abrasive tape, hardness of the photosensitive layer surface of the photoreceptor 2, the abrading extent, and the like.

The photoreceptor holding device 9b is provided with a rack 9b1 and a base table 9b2. The rack 9b1 comprises a holding member 9b11 provided with a holding means 9b13 to hold the photoreceptor 2 and a holding member 9b12 provided with a holding means (not shown in the drawing). The photoreceptor holding device 9b may be any one which can fix or remove the photoreceptor 2 and is, for example, a three nail chuck. The holding means provided on the holding member 9b12 may be the same as the holding means 9b13. The photoreceptor can be horizontally held by the holding member 9b11 and the holding member 9b12.

Numeral 9b14 designates a motor provided on the rack 9b1 and a rotation shaft of the motor 9b14 is connected to the holding means 9b13 of the holding member 9b11 and the photoreceptor 2 held by holding members can be rotated by operating the motor 9b14.

The rotation rate (number of revolutions) can be set according to the type of the abrasive tape 10, pressure of the abrasive tape onto the photoreceptor, the abrasion amount and the like, but is from 10 to 1,000 rpm only as a guide. The conveyance rate can also be set according to the type of the abrasive tape 10, pressure of the abrasive tape onto the photoreceptor, the abrasion amount and the like, but is from 50 to 450 mm/min only as a guide.

Numeral 9b15 designates a shaft for movement, connected to a moving means (for example, a stepping motor), which is provided on the opposite side of a rack 4b1 provided with a motor 9b14. A rack 9b1 is movable by a moving means (for example, a stepping motor) along a traveling channel 9a31 provided on the a base table 9b2 (in the direction designated by the arrow or X-axis direction).

The moving rate of the rack 9b1 can optimally be set according to the type of the abrasive tape 10, pressure of the abrasive tape onto the photoreceptor, an abrasion amount and the like, but is from 10 to 50 mm/min only as a guide. Further, the moving amount can optimally be controlled according to the width of the abrasion area of the photosensitive layer 202 parallel to the shaft of the photoreceptor 2.

The pressing extent to set the depth of a lower portion (same as the height of the lower portion) which is formed by abrasion on the surface of the photosensitive layer 202 or the photoreceptor is set to be preferably from 1.0 to 0.7 mm, and more preferably from 0.2 to 0.7 mm, taking into account holding property of an external additive or a lubricant supplied from the toner at the initial stage after starting image formation, streak defects on the image and cleaning property.

In FIGS. 4a and 4b, the abrading apparatus 9 shows the case in which the abrasive tape-conveying device 9a and the photoreceptor holding device 9b orthogonally move in the direction of the Y-axis and the X-axis, respectively. Alternatively, the abrasive tape-conveying device 9a and the photoreceptor holding device 9b orthogonally move in the direction of the X-axis and the Y-axis, respectively.

In the abrading apparatus 9, the photosensitive layer surface can be abraded by moving an abrading member on a backup roll parallel to the rotation axis of the electrophotographic photoreceptor having a photosensitive layer on the conductive substrate, while pressing the abrading member against the photosensitive layer surface and also by feeding the abrading member.

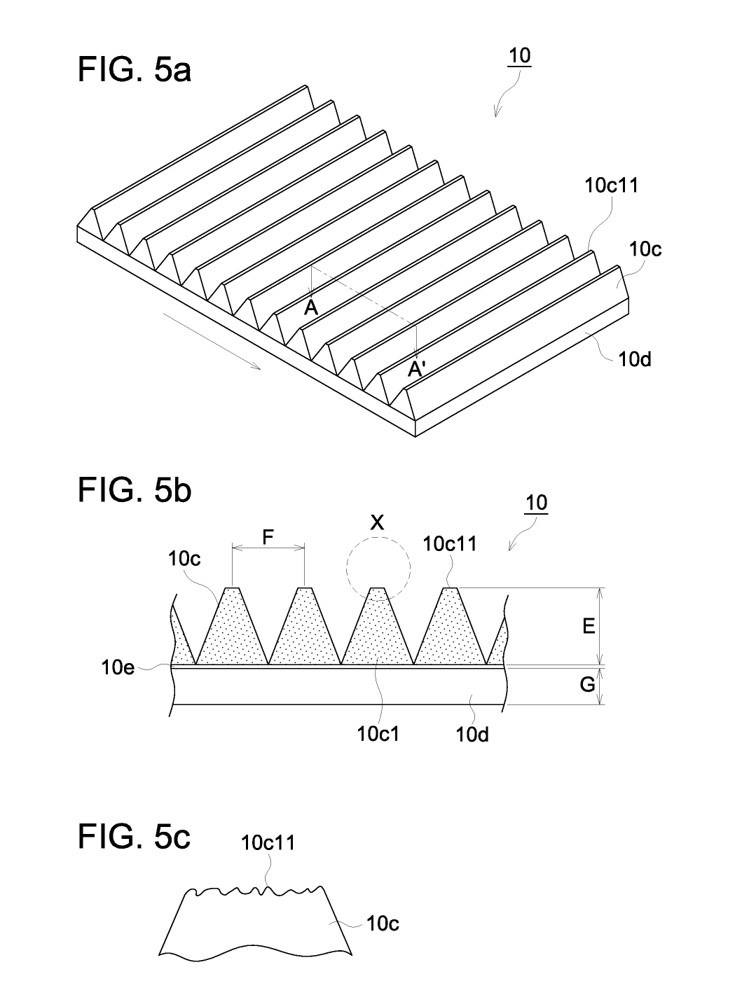

FIGS. 5a-5c illustrate enlarged view showing the abrasive surface of the abrasive tape used in the abrading apparatus shown in FIGS. 4a-4b. FIG. 5a is an enlarged schematic view of the abrasive surface of the abrasive tape used in the abrading apparatus shown in FIGS. 4a-4b. FIG. 5b is a schematic sectional view along A-A′ of FIG. 5a. FIG. 5c is an enlarged schematic view of the portion designated by X in FIG. 5b.

In the figures, the numeral 10 represents an abrasive tape as an abrading member. The numeral 10c represents a solid body with a 3-dimensional form, which is provided on a substrate 10d and exhibits a triangular sectional form. The solid body 10c is formed of a binder resin containing abrasive grains 10c1. The numeral 10c11 indicates the top face of the solid body and the top face is in contact with the photosensitive layer surface of a photoreceptor. The solid body 10c is a continuous form in the width direction of the substrate 10d. A lower portion is formed between solid bodies (10c) and a higher portion is formed on the top face 10c11, whereby the abrading surface of the abrasive tape forms an irregular surface having higher portions and lower portions. The width direction of the substrate 10d refers to the direction vertical to the conveyance direction (as indicated by an arrow) of the abrasive tape 10.

When abrading the photosensitive layer surface of the photoreceptor 2 by using the abrasive tape 10 in the abrading apparatus (as shown in FIGS. 4a-4b), the top face 10c11 is pressed so that it is brought into contact with the photosensitive layer surface parallel to the axis of the photoreceptor 2 (as shown in FIGS. 4a-4b).

The top face 10c11 allows the contact area of a solid body containing abrasive grains of an abrasive tape with the photosensitive layer surface to increase, whereby concentration of pressure to the top of the solid body containing abrasive grains is dispersed, enabling to prevent occurrence of streak-like flaws.

A surface roughness (Rz) of the top face 10c11 is preferably from 0.01 to 0.5 μm taking into account surface roughness of the top surface finally formed on the surface of the photoreceptor, cleaning property, streak-like flaws in the image.

The surface roughness (Rz) is a value determined by using a laser microscope (VK-9510, made by KEYENCE Corp.).

The designation “E” indicates the height from the surface of the substrate 10d of the solid body 10c. The height (E) is not specifically limited so long as it is at a level which is capable of holding abrasive grains 10c1, but is preferably from 10 to 100 μm, taking into account abrasiveness and dropping of abrasive grains.

A height E indicates the value determined by using a laser microscope (VK-9510, made by KEYENCE Co., Ltd.).

A distance F is the length of from the center of the top face to the center of a top face of an adjacent solid body (10c). The distance F is preferably from 30 to 100 μm, taking into account clogging of the abrasive tape, due to abrasive residue in abrasion uniformity. A distance F indicates the value determined by using a laser microscope (VK-9510, made by KEYENCE Co., Ltd.).

The designation “G” indicates the thickness of the substrate 10d. A thickness G is preferably from 10 to 100 μm, taking into account workability of an abrasive tape and its close contact to the photosensitive layer.

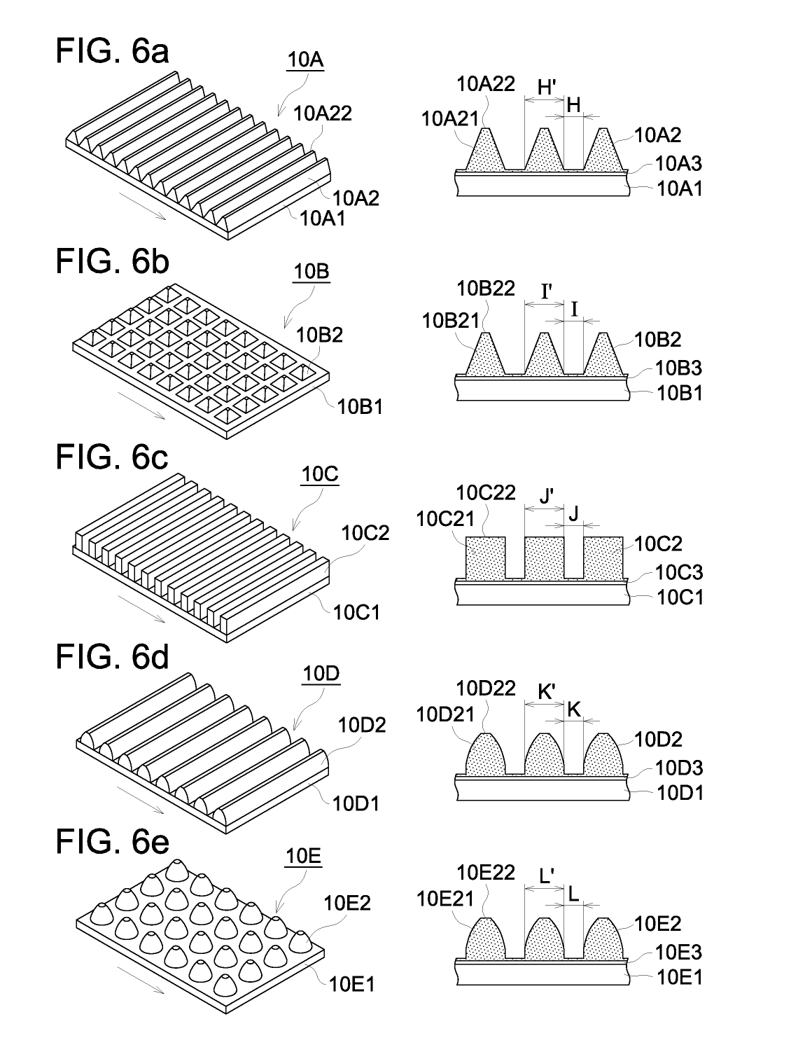

FIGS. 6a-6e illustrate enlarged schematic views of other shapes of the abrasive surface of abrasive tape used in an abrading apparatus, as shown in FIGS. 4a-4b.

The abrasive tape, as shown in FIG. 6a will now be described. The right side of this drawing shows an enlarged schematic sectional view in a conveyance direction (in the direction indicated by the arrow) of an abrasive tape.

In the drawing, 10A designates an abrasive tape as an abrasive member and 10A2 indicates a solid body with a trapezoidal cross-section, provided on a substrate 10A1. In the abrasive tape 10A, a sheet-form material in which solid bodies (10A2) are continuously connected is provided on the substrate 10A1 through an adhesive layer 10A3. The solid body 10A2 is composed of a binder resin containing abrasive grains (10A21). The designation 10A22 indicates the top face of the solid body 10A2 which is capable of being in contact with the photosensitive layer surface of the photoreceptor. Solid bodies (10A2) are arranged in a continuous form in the width direction of the substrate 10A1, forming a recessed portion between adjacent solid bodies (10A2) and a protruded portion at the top face 10A22 to construct an irregular surface having higher portions and lower portions for the abrasive surface of an abrasive tape. The width direction of the substrate 10A1 refers to a direction perpendicular to the conveyance direction of the abrasive tape 10A (as indicated by the arrow).

The designation H indicates the distance between a base table portions on the substrate 10A1 provided thereon with adjacent solid bodies (10A2). The distance H is preferably 10 to 500 μm, taking into account clogging of the abrasive tape, due to abrasive residues and abrasion uniformity.

The distance H indicates a value determined by using a laser microscope (VK-9510, made by KEYENCE Corp.).

The designation H′ indicates the width at the position exhibiting a maximum width of the solid body 10A2 in the conveyance direction of the abrasive tape 10A (as indicated by the arrow). The width H′ is preferably 30 to 500 μm taking into account strength of the solid body and abrasion uniformity onto the photoreceptor surface.

The width H′ indicates a value determined by using a laser microscope (VK-9510, made by KEYENCE Co., Ltd.).

The height from the surface of the substrate 10A1 of the solid body 10A2 and the surface roughness (Rz) are the same as in the case of the abrasive tape 10 shown in FIGS. 5a-5c.

The abrasive tape, as shown in FIG. 6b will now be described. The right side of this drawing shows an enlarged schematic sectional view in the conveyance direction (in the direction indicated by the arrow) of the abrasive tape.

In this drawing, 10B designates the abrasive tape as an abrasive member and 10B2 indicates a solid body with a quadrangular pyramid form, provided on a substrate 10B1. In the abrasive tape 10B, a sheet-form material in which solid bodies 10B2 are continuously formed is provided on the substrate 10B1 through an adhesive layer 10B3. The solid body 10B2 is composed of a binder resin containing abrasive grains 10B21. The designation 10B22 indicates the top face of the solid body 10B2 which is capable of being in contact with the photosensitive layer surface of the photoreceptor. Solid bodies 10B2 are arranged in a continuous form in the length direction and in the width direction of the substrate 10B1 at equidistant intervals, forming a recessed portion among adjacent solid bodies (10B2) and a protruded portion at the top face 10B22 to structure an irregular surface having higher portions and lower portions on the abrasive surface of the abrasive tape. The width direction of the substrate 10B1 refers to the direction perpendicular to the conveyance direction of the abrasive tape 10B (as indicated by the arrow). The length direction of the substrate 10B1 refers to the conveyance direction of the abrasive tape 10B (as indicated by an arrow).

The designation “I” indicates a distance between a base table portions on the substrate 10B1 provided thereon with adjacent solid bodies (10B2). The distance I is the same as H of the abrasive tape 10A shown in FIG. 6A.

The designation I′ indicates a width at the position exhibiting a maximum width of the solid body 10B2 in the conveyance direction of the abrasive tape 10B (as indicated by the arrow). The width I′ is the same as the width H′ of the solid body 10A2 of the abrasive tape 10A shown FIG. 6a.

The height from the surface of the substrate 10B1 of the solid body 10B2 and the surface roughness (Rz) of the top surface 10B22 are the same as in the case of the abrasive tape 10 shown in FIGS. 5a-5c.

The abrasive tape shown in FIG. 4c will be described. The right side of this drawing shows an enlarged schematic sectional view in the conveyance direction (in the direction indicated by the arrow) of the abrasive tape.

In this drawing, 10C designates the abrasive tape as an abrasive member and 10C2 indicates a solid body with a rectangular cross-section, provided on a substrate 10A1. In the abrasive tape 10C, a sheet-form material in which solid bodies (10C2) are continuously connected is provided on the substrate 10C1 through an adhesive layer 10C3. The solid body 10C2 is composed of a binder resin containing abrasive grains (10C21). The designation 10C22 indicates the top face of the solid body 10C2 which is capable of being in contact with the photosensitive layer surface of the photoreceptor. Solid bodies (10C2) are arranged in a continuous form in the width direction of the substrate 10C1, forming a recessed portion between adjacent solid bodies (10C2) and a protruding portion of a top face 10C22 to structure an irregular surface having higher portions and lower portions on the abrasive surfaces of the abrasive tape. The width direction of the substrate 10C1 refers to the direction perpendicular to the conveyance direction of the abrasive tape 10C (as indicated by the arrow).

The designation J indicates the distance between a base table portions on the substrate 10C1 provided thereon with adjacent solid bodies (10C2). The distance I is the same as H of the abrasive tape 10A, as shown in FIG. 6A.

The designation J′ indicates the width at the position exhibiting a maximum width of the solid body 10C2 in the conveyance direction of the abrasive tape 10C (as indicated by the arrow). The width J′ is the same as the width H′ of the solid body 10A2 of the abrasive tape 10A shown FIG. 6a.

The height from the surface of the substrate 10C1 of the solid body 10C2 and the surface roughness (Rz) of the top surface 10C22 are the same as in the case of the abrasive tape 10 shown in FIGS. 5a-5c.

An abrasive tape shown in FIG. 6d will now be described. The right side of this drawing shows an enlarged schematic sectional view in a conveyance direction (in the direction indicated by the arrow) of an abrasive tape.

In this drawing, 10D designates an abrasive tape as an abrasive member and 10D2 indicates a solid body with a ellipsoidal section, provided on a substrate 10D1. In the abrasive tape 10D, a sheet-form material in which solid bodies (10D2) are continuously attached is provided on the substrate 10D1 through an adhesive layer 10D3. The solid body 10D2 is composed of a binder resin containing abrasive grains (10D21). The designation 10A22 indicates the top face of the solid body 10D2 which is capable of being in contact with the photosensitive layer surface of the photoreceptor. Solid bodies (10D2) are arranged in a continuous manner in the width direction of the substrate 10D1, forming a recessed portion between adjacent solid bodies (10D2) and a protruded portion at the top face 10D22 to structure an irregular surface having higher portions and lower portions on the abrasive surface of the abrasive tape. The width direction of the substrate 10D1 refers to a direction perpendicular to the conveyance direction of the abrasive tape 10D (as indicated by the arrow).

The designation K indicates the distance between a base table portions on the substrate 10D1 provided thereon with adjacent solid bodies (10D2). The distance K is the same as H of the abrasive tape 10A, as shown in FIG. 6A.

The designation K′ indicates the width at the position exhibiting a maximum width of the solid bodies 10D2 in the conveyance direction of the abrasive tape 10D (as indicated by the arrow). The width K′ is the same as the width H′ of the solid body 10A2 of the abrasive tape 10A shown in FIG. 6a.

The height from the surface of the substrate 10D1 of the solid body 10D2 and the surface roughness (Rz) of the top surface 10C22 are the same as in the case of the abrasive tape 10 shown in FIGS. 5a-5c.

The abrasive tape shown in FIG. 6e will now be described. The right side of this drawing shows an enlarged schematic sectional view in the conveyance direction (in the direction indicated by the arrow) of the abrasive tape.

In this drawing, 10E designates an abrasive tape as an abrasive member and 10E2 indicates a solid body with a spindle form, provided on a substrate 10E1. In the abrasive tape 10E, a sheet-form material in which solid bodies (10E2) are continuously connected is provided on the substrate 10E1 through an adhesive layer 10E3. The solid body 10E2 is composed of a binder resin containing abrasive grains (10E21). The designation 10E22 indicates the top face of the solid body 10E2 which is capable of being in contact with the photosensitive layer surface of a photoreceptor. Solid bodies (10E2) are arranged in a continuous manner in the length direction and in the width direction of the substrate 10E1 at equidistant intervals, forming a recessed portion between adjacent solid bodies (10E2) and a protruding portion at the top face 10E22 to structure an irregular surface having higher portions and lower portions on the abrasive surface of the abrasive tape. The width direction of the substrate 10E1 refers to the direction perpendicular to the conveyance direction of the abrasive tape 10E (as indicated by the arrow). The length direction of the substrate 10E1 refers to the conveyance direction of the abrasive tape 10E (as indicated by the arrow).

The designation K indicates the distance between a base table portions on the substrate 10E1 provided thereon with adjacent solid bodies (10E2). The distance L is the same as H of the abrasive tape 10A, as shown in FIG. 6a.

The designation L′ indicates the width at the position exhibiting a maximum width of the solid body 10E2 in the conveyance direction on the abrasive tape 10E (as indicated by the arrow). The width L′ is the same as the width H′ of the solid body 10A2 of the abrasive tape 10A shown FIG. 6a.

The height from the surface of the substrate 10E1 under the solid body 10E2 and the surface roughness (Rz) of the top surface 10E22 are the same as in the case of the abrasive tape 10 shown in FIGS. 5a-5c.

The thickness of the substrate of abrasive tapes shown in FIGS. 6a-6e is the same as that of the substrate 10 of the abrasive tape 10 shown in FIGS. 5a-5c.

The form of the abrasive surface used in the invention is not limited to the form shown in FIGS. 5a-5c and FIGS. 6a-6e but a form of the higher portion (or protruded portion) may be any one which has an irregular structure having higher portions and lower portions formed by solid bodies on the substrate.

The amount of abrasive grains contained in the solid body of the abrasive tape, as shown in FIGS. 5a-5c and FIGS. 6a-6e is preferably from 5 to 80% by mass, a base tabled on the solid body, taking into account abrasiveness and dropping of abrasive grains.

The average grain size of the abrasive grains is preferably from 0.01 to 50 μm. The average grain size of abrasive grains is, for example, that obtained by a median diameter (D50) determined in a centrifugal sedimentation method or the like.

Using an abrasive member having an abrasive surface with a form, as shown in FIGS. 5a-5c and FIGS. 6a-6e, minute channels can be formed by pressing a continuous- or discontinuous-form higher portions onto the surface of a photosensitive layer of the photoreceptor. Further, using an abrading apparatus (9) shown in FIGS. 4a-4b, abrasion can be stably performed without forming abrasion streaks, while moving the abrasive tape as an abrasive member and the photoreceptor relatively in parallel with pressing the abrasive tape onto the photosensitive layer surface of the photoreceptor and rotating the photoreceptor. Since abrasion cannot be stably performed due to wearing or clogging of the abrading surface of the abrasive tape, it is preferred that an abrasive tape is appropriately fed from a feeder (not shown in the drawing) and is taken up by a reeling device (not shown in the drawing) to renew the abrading surface.

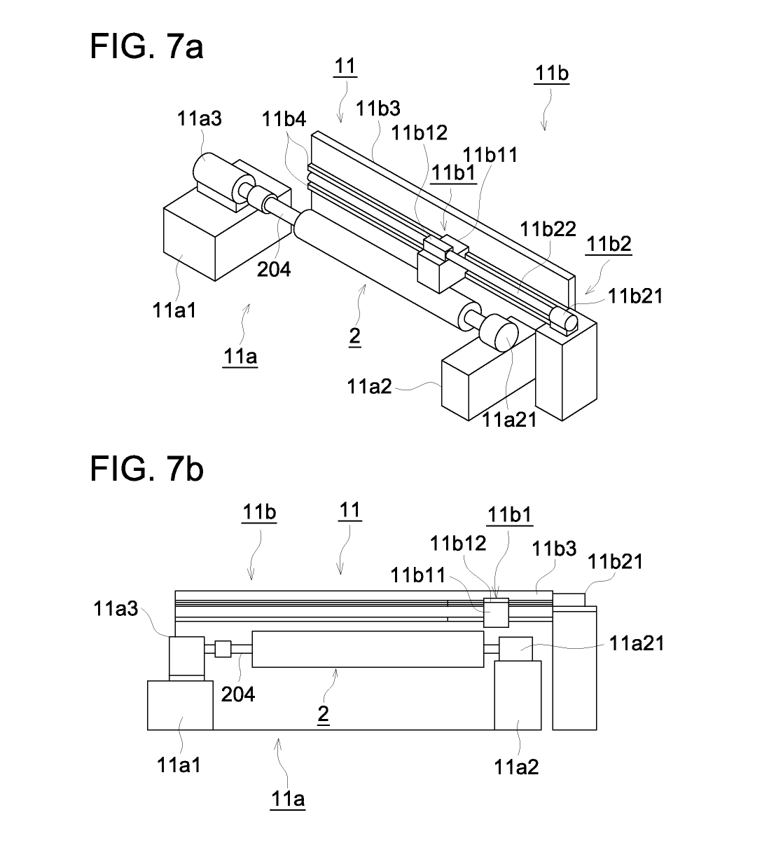

FIGS. 7a and 7b show schematic view of an irregular surface forming apparatus to form the shape composed of higher portions and lower portions on the surface of the photoreceptor. FIG. 7a shows over view of an irregular surface forming apparatus to form the shape composed of higher portions and lower portions on the surface of the photoreceptor. FIG. 7b show front schematic view of an irregular surface forming apparatus illustrated in FIG. 7a.

In the figure, 11 designates an irregular surface forming apparatus. Irregular surface forming apparatus 11 comprises holding member 11a and laser irradiation member 11b. Holding member 11a has first holding table 11a1, second holding table 11a2 and driving motor 11a3.

Driving motor 11a3, disposed on first holding table 11a1, is connected to a rotation axis through holding shaft 204 of photoreceptor and a connecting member driving motor 11a3.

Second holding table 11a2 has bearing 11a21 holding another holding shaft 204 of photoreceptor 2, and a photoreceptor 2 can be hold and rotated driven by rotation of driving motor 11a3.

Laser irradiation member 11b has light source member 11b1 and driving section 11b2. Light source member 11b1 has frame 11b11 containing a light source (not shown in the drawing). In this figure, power supply and control section to the light source (not shown in the drawing) are not shown. A mask having patterns (not shown in the drawing) is disposed between light source member 11b1 and photoreceptor 2, so that surface of the photosensitive layer of photoreceptor 2 is irradiated through the mask. The surface of the photosensitive layer of photoreceptor 2 is irradiated via light source in the frame 11b11, and photosensitive layer at the irradiated area is removed to form lower portions.

Driving section 11b2 has motor 11b21 and guide rail attaching plate 11b3. Guide rail attaching plate 11b3 has two guide rails 11b4, which hold frame 11b11 and transport frame 11b11 parallel to rotation axis of photoreceptor 2 hold by holding member 11a (in the direction designated by the arrow).

Motor 11b21 has bolt 11b22, which is connected spirally to sliding nut 11b12 and transports frame 11b11 wider than the width of photoreceptor 2 hold by holding member 11a.

Frame 11b11 can be transported in width direction parallel to rotation axis of photoreceptor 2 by driving motor 11b21.

The photoreceptor may be one having rough surface subjected to roughening surface process via roughening apparatus shown FIGS. 4a and 4b, or one having no rough surface without subjected to roughening surface process, and can be selected according to a method to forming irregular surface composed of higher and lower portions.

Laser is used for the light source. The laser applicable to the invention is preferably those having wave length absorbed by outermost layer. Examples include YAG laser, YVO₄ laser, YLF laser, YAlO₃ laser, excimer laser or the like. YAG laser is particularly preferable because high power is obtained and can be widely used with light fiber as the transmission medium.

Methods for fanning the shape composed of higher portions and lower portions on the surface of the photosensitive layer of the photoreceptor by employing an apparatus shown in the figures are not restricted, and include the following methods are listed as preferable examples.

### 1. Intermittent Irradiation Type

Laser is irradiated through a mask to a photosensitive layer of the photoreceptor by a process wherein laser is irradiated when the photoreceptor is not rotated, and after that, photoreceptor 2 is allowed to rotate to the next irradiation area and rotation is stopped there, laser is irradiated when the photoreceptor is not rotated. After forming the shape on the peripheral surface of the photosensitive layer by repeating this operation, light source member 11b1 is moved to next irradiation position in rotation axis of the photoreceptor 2 by driving motor 11b21, the above described operation is conducted to form the shape on the surface of the photosensitive layer. The shape is formed on a whole surface of the photoreceptor by conducting the operation to the end of the photoreceptor 2. Shape of the higher portions can be modified if necessary by changing the shape of mask pattern.

### 2. Continuous Irradiation Type

Laser is irradiated through a mask to a photosensitive layer of the photoreceptor by a process wherein laser is irradiated from the end to the another end of the photoreceptor 2 by conducting the rotation of the photoreceptor 2 and transportation of light source member 11b1 in axis direction simultaneously. Grooves of spiral shape (lower portions) are formed on the surface of the photosensitive layer of the photoreceptor 2. Distance between the grooves (lower portions) can also be adjusted by adjusting the transportation speed of the light source member 11b1 and rotation speed of the photoreceptor. After irradiation of laser from an end to another end, and then the irradiation is conducted from the reverse side end to another end. Grooves are formed in a state that spiral shape grooves (lower portions) are formed crossing, and the shape of higher portions and lower portions are formed on a surface of the photosensitive layer. The higher portion as formed is square column having top surface of in a shape of a diamond.

Since laser irradiation conditions for intermittent irradiation type, continuous irradiation type vary depending on kind of material composing a photosensitive layer depth of the lower portions or the like, condition such as output power and frequency is adjusted corresponding to the kind of material composing a photosensitive layer depth of the lower portions or the like, and laser is irradiated on the photosensitive layer of the photoreceptor.

A conventional method can be adopted for the laser scanning methods, and galvano-scanning method is particularly preferably. Taking into account the heat accompanied with laser irradiation, laser irradiation part is preferably cooled by a conventional method such as air-cooling, chiller cooling method and the like.

This figure shows a the shape composed of higher portions and lower portions forming apparatus in which light source member is moved parallel to a rotation axis of a photoreceptor while the photoreceptor is allowed to rotate in a state that the holding position of the photoreceptor is fixed. It is also possible that the photoreceptor is moved along with the rotation direction of the photoreceptor while the light source member is fixed.

Manufacturing method of mask as used is described.

Material for the mask is preferably one which transmits laser light and has heat resistance, and includes, for example, colorless transparent glass. Pattern composed of laser transmission parts and laser non-transmission parts is formed. Methods for forming the pattern include those as followed.

1) Conducting pattern processing on the glass by, for example, processing via eximer laser ArF 193 nm, and embedding metal containing substance which does not transmit laser light and is not sublimated such as aluminum, tin, copper, titanium and chromium.

2) Coating material, which does not transmit laser light, such as aluminum, tin, copper, titanium and chromium on the glass with a pattern.

3) Coating material, which does not transmit laser light, such as aluminum, tin, copper, titanium and chromium on the whole surface of glass, and removing in arbitral shape to form a pattern.

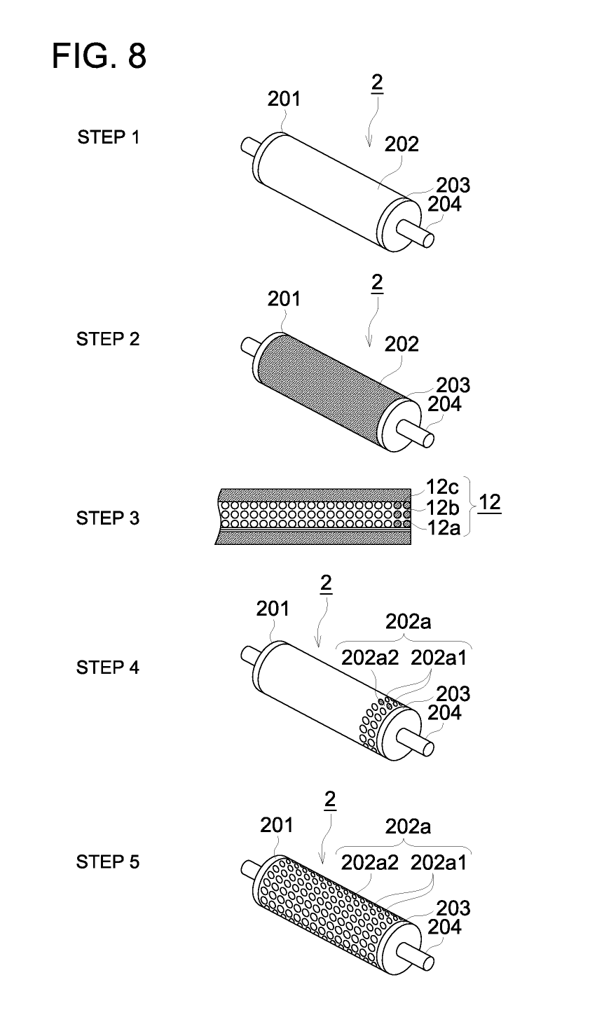

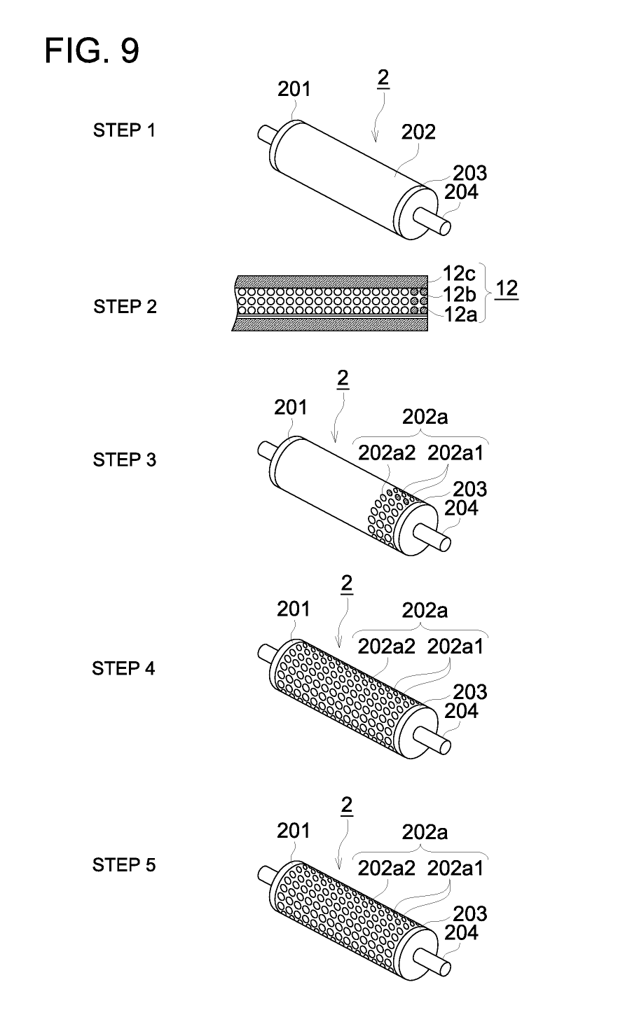

A method to form the shape composed of higher portions and lower portions on the surface of a photosensitive layer by employing the abrading apparatus shown by FIGS. 4a and 4b and the shape composed of higher portions and lower portions forming apparatus 11 shown in FIGS. 7a and 7b is described by FIGS. 8 and 9.

FIG. 8 shows schematic flow chart of the manufacturing photoreceptor in which pattern of the shape composed of higher portions and lower portions on the surface of the photoreceptor is formed by an intermittent irradiation method after abrading the surface of a photosensitive layer of the a photoreceptor.

Photoreceptor 2, having cylindrical shape electro-conductive substrate 201, photosensitive layer 202 formed on periphery of electro-conductive substrate 201, non-photosensitive layer-forming portions 203 on both ends of electro-conductive substrate 201, holding shafts 204 to attach to an electrophotographic image forming apparatus (not shown in the drawing) in both end parts, is prepared in Step 1

Whole surface of a photosensitive layer of photoreceptor 2 prepared in Step 1 is abraded via abrading apparatus shown in FIG. 4, in Step 2.

In Step 3, mask 12 is equipped to light source member 11b1 (FIG. 7) of the shape composed of higher portions and lower portions forming apparatus 11 (FIG. 7). Mask 12 has laser light transmitting parts 12b and 12c (white part in figure) and laser light non-transmitting part 12a (dark part in figure). Size of mask 12 is determined optimally taking account of size of photoreceptor 2 and light source member 11b1 (FIG. 7). Size of laser light transmitting parts 12b and 12c (white part in figure), and shape and area of laser light non-transmitting part 12a (dark part in figure) can be varied in accordance with the shape composed of higher portions and lower portions formed on the photosensitive layer.

In Step 4, laser is irradiated on the surface of the photosensitive layer 202 through mask 12 via the shape composed of higher portions and lower portions forming apparatus 11 shown in FIG. 7 in state that photoreceptor 2 and light source member 11b1 (FIG. 7) are fixed. Groove (lower portions) 202a1 is formed by removing photosensitive layer 202 at portions to which laser light is irradiated through laser transmitting parts 12b and 12c, and portions to which laser light is not irradiated remains as higher portions 202a2 to form the shape composed of higher portions and lower portions 202a on the surface of photosensitive layer 202. After that photoreceptor 2 is rotated in accordance with the region to be irradiated and if fixed, laser is irradiated. The shape composed of higher portions and lower portions of one cycle for periphery of photosensitive layer 202 is formed by repeating the processes.

In Step 5, light source member 11b1 (FIG. 7) is moved to neighboring region to a region on which laser has been irradiated in Step 4 in a rotation direction of photoreceptor 2, and the same operation is repeated.

Photoreceptor 2 on which the shape composed of higher portions and lower portions 202a is formed on photosensitive layer 202 shown in FIGS. 2 and 3 is manufactured by repeating the same operation of Step 5. Surface of the photosensitive layer corresponding to laser transmitting parts 12b and 12c of mask 12 is removed by laser irradiation and becomes lower portions 202a1. Portions corresponding to laser non-transmitting parts 12a (dark part in figure) remain to form higher portions 202a2.

FIG. 9 shows schematic flow chart of manufacturing photoreceptor by abrading surface of the higher portions after forming pattern of the shape composed of higher portions and lower portions on the surface of the photoreceptor by an intermittent irradiation method.

Photoreceptor 2, having cylindrical shape electro-conductive substrate 201, photosensitive layer 202 formed on periphery of electro-conductive substrate 201, non-photosensitive layer-forming portions 203 on both ends of electro-conductive substrate 201, holding shafts 204 to attach to an electrophotographic image forming apparatus (not shown in the drawing) in both end parts, is prepared in Step 1.

In Step 2, mask 12 is equipped to light source member 11b1 (FIG. 7) of the shape composed of higher portions and lower portions forming apparatus 11 (FIG. 7). Mask 12 has laser light transmitting parts 12b and 12c (white part in figure) and laser light non-transmitting part 12a (dark part in figure). Size of mask 12 is determined optimally taking account of size of photoreceptor 2 and light source member 11b1 (FIG. 7). Size of laser light transmitting parts 12b and 12c (white part in figure), and shape and area of laser light non-transmitting part 12a (dark part in figure) can be varied in accordance with the shape composed of higher portions and lower portions formed on the photosensitive layer.

In Step 3, the shape composed of higher portions and lower portions 202a composed of lower portions 202a1 and higher portions 202a2 on the surface of photosensitive layer 202 of the photoreceptor 2 by conducting the same operations as Steps of 4 and 5 as described in FIG. 8.

In Step 4, whole surface of photosensitive layer 202 of photoreceptor 2, on which patterning the shape composed of higher portions and lower portions 202a is formed, is abraded by an abrading apparatus 9 shown in FIG. 4. Photoreceptor 2 having abraded top surface of higher portions 202a2 and the shape composed of higher portions and lower portions 202a on photosensitive layer 202 as shown in FIGS. 2 and 3 is formed.

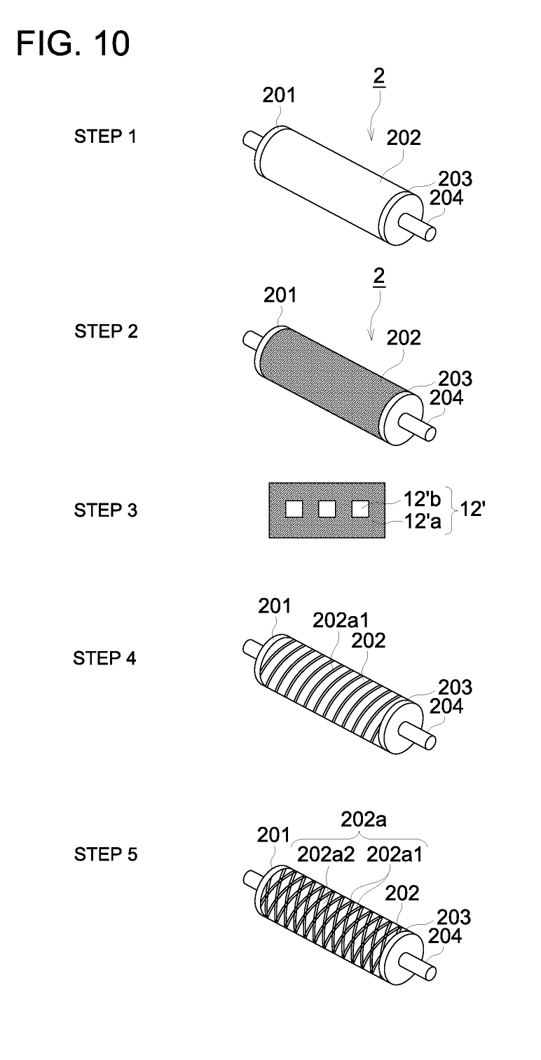

FIG. 10 shows schematic flow chart of the manufacturing photoreceptor in which patterns of the shape composed of higher portions and lower portions on the surface of the photoreceptor is formed by a continuous irradiation method after abrading the surface of a photosensitive layer of the a photoreceptor.

Photoreceptor 2, having cylindrical shape electro-conductive substrate 201, photosensitive layer 202 formed on periphery of electro-conductive substrate 201, non-photosensitive layer-forming portions 203 on both ends of electro-conductive substrate 201, holding shafts 204 to attach to an electrophotographic image forming apparatus (not shown in the drawing) in both end parts, is prepared in Step 1.

Whole surface of a photosensitive layer of photoreceptor 2 prepared in Step 1 is abraded via abrading apparatus shown in FIG. 4, in Step 2.

In Step 3, mask 12′ is equipped to light source member 11b1 (FIG. 7) of the shape composed of higher portions and lower portions forming apparatus 11 (FIG. 7). Mask 12′ has laser light non-transmitting part 12′a (dark part in figure) and laser light transmitting parts 12′b (white part in figure). Size of mask 12′ is determined optimally taking account of size of photoreceptor 2 and light source member 11b1 (FIG. 7). Area of laser light transmitting parts 12′b (white part in figure), and shape and area of laser light non-transmitting part 12a (dark part in figure) can be varied in accordance with the width of the lower portions to be formed on the photosensitive layer.

In Step 4, laser light is irradiated on photosensitive layer 202 through mask 12′ by the shape composed of higher portions and lower portions forming apparatus 11, while conducting moving light source member 11b1 (FIG. 7) photoreceptor 2 from an end to the other end in rotating direction of photoreceptor 202 and rotating photoreceptor 2 simultaneously. Groove in spiral shape (lower portions) 202a1 is formed by removing photosensitive layer 202 at portions irradiated by laser through laser transmitting parts 12′b. Portions to which laser light is not irradiated remain as higher portions 202a2 to form the shape composed of higher portions and lower portions 202a on the surface of photosensitive layer 202. Distance between grooves (lower portions) 202a1 can be adjusted by controlling moving speed of light source member 11b1 (FIG. 7) and rotating speed of photoreceptor 2.

In Step 5, laser light is irradiated during light source member 11b1 (FIG. 7) is moved from an end to other end of photoreceptor 2, and then laser light is irradiated during light source member 11b1 (FIG. 7) is moved from the different end to other end of photoreceptor 2 opposite to previous. Thus groove parts (lower portions) 202a1 in spiral shapes were formed in crossing state on photosensitive layer of photoreceptor 2, regions on which the laser light are not irradiated remains on photosensitive layer 202 to form higher portions 202a2. The shape composed of higher portions and lower portions 202a is formed on photosensitive layer 202. The higher portion 202a2 as formed is square column having top surface of in a shape of a diamond.

Patterns of laser transmitting region and laser non-transmitting regions in mask 12 to form patterns of the shape composed of higher portions and lower portions are not restricted, and can be optionally varied according to density of higher portions, size of top surface of higher portions, shape of top surface of higher portions and arrangement of higher portions.

The following advantages are obtained by employing an image forming method comprising steps of forming latent image on a photoreceptor, developing the latent image by a developer containing a polymerization toner, wherein the photoreceptor comprises a photosensitive layer provided on a surface of a cylindrical electroconductive substrate, a surface of the photoreceptor has a shape composed of plural lower portions and plural higher portions, a surface roughness of a top surface of the higher portions is 0.01 to 0.5 μm, and a volume based median particle diameter of the polymerization toner is 3 to 8 μm.
1. Charge distribution is uniform when charge is applied, and images having constant quality are obtained.
2. High cleaning performance is obtained when a small particle size toner is used and images having constant quality are obtained.
3. High blade slipping performance to ensure high speed image forming is obtained, cleaning performance is improved and images having constant quality are obtained.

In the following, there will be described a specific structure of a photoreceptor which is preferably usable in the invention.

### Conductive Support

An electrically conductive support usable in the invention preferably is a belt-form or cylindrical support, of which a cylindrical support is preferred in term of easiness in designation of an image forming apparatus. A cylindrical conductive support refers to a support of a cylindrical form capable of performing endless image formation and its cylindricity is preferably from 5 to 40 μm, and more preferably from 7 to 30 μm.

Specific examples of a conductive support include a metal drum of aluminum or nickel, a plastic drum on which aluminum, tin oxide, indium oxide or the like is deposited, and a paper or plastic drum coated with an electrically conductive material. The specific resistivity of a conductive support is preferably not more than 10³ Ωcm.

### Intermediate Layer

An intermediate layer is formed by coating, on a conductive support, a coating composition containing a binder, a dispersing solvent and the like, followed by being dried. Examples of a binder used for an intermediate layer include a polyamide resin, vinyl chloride resin, a vinyl acetate resin and a copolymeric resin containing at least two repeating units of the foregoing resins. Of these resins is preferred a polyamide resin which is capable of inhibiting an increase of residual potential. A filler such as titanium oxide or zinc oxide or an antioxidant may appropriately be incorporated in an intermediate layer to achieve enhanced potential characteristics or reduction in black spot defect or the moire effect.

A solvent used for preparation of an intermediate layer coating composition is preferably one which is capable of dispersing appropriately added inorganic particles and dissolving a polyamide resin. Specifically, alcohols having 2-4 carbon atoms, such as methanol, ethanol, n-propyl alcohol, iso-propyl alcohol, n-butanol, t-butanol and sec-butanol are preferred. These solvents are contained preferably in an amount of 30 to 100%, more preferably 40 to 100% and still more preferably 50 to 100% of total solvents. The foregoing solvents may be used in combination with an auxiliary solvent. Examples of such an auxiliary solvent include benzyl alcohol, methylene chloride, cyclohexane, tetrahydrofuran and the like. The thickness of an intermediate layer is preferably from 0.2 to 40 μm, and more preferably from 0.3 to 20 μm.

### Photosensitive Layer

A photosensitive layer may be a single layer structure to allow a charge generation function and a charge transport function to exist in one layer, but preferably has a layer structure in which functions of the photosensitive layer are separated, as a charge generation layer (CGL) and a charge transport layer (CTL). Such a function separation structure can reduce an increase of residual potential along with repeated use and easily controls other electrophotographic characteristics according to the purpose thereof. A negative-charged photoreceptor has a structure composed of an intermediate layer provided thereon with a charge generation layer (CGL) and further thereon with a charge transport layer (CTL). A positive-charged photoreceptor has an opposite layer structure to the foregoing negative-charged photoreceptor. Of these layer structures of a photoreceptor is preferred a negative-charged photoreceptor having the function-separating structure described above.

There will be described the individual layers of a photosensitive layer of a function-separated photoreceptor.

### Charge Generation Layer (CGL)

A charge generation layer (CGL) contains a charge generation material (CGM) and a binder resin and other additives may be contained therein. Of charge generation materials (CGM) known in the art, those of an oxytitanium phthalocyanine exhibiting a maximum X-ray refraction peak at a Bragg angle (2θ±0.2) of 27.2° and a benzimidazole perylene exhibiting a maximum peak at a Bragg angle of 12.4° exhibit little deterioration and inhibited increase of residual potential during repeated use.

When using a binder as a dispersing medium for a charge generation material (CGM) and a charge transfer material (CTM), resins known in the art may be used as a binder. Specific examples of a preferred resin include a polyvinyl formal resin, a polyvinyl butyral resin, a silicone resin, a silicone-modified butyral resin and a phenoxy resin. The ratio of charge generation material (CGM) to binder resin preferably is 20 to 600 parts of a charge generation material (CGM) by mass to 100 parts by mass of binder resin. The use of such a resin enables to minimize an increase of residual potential in repeated use. A thickness of a charge generation layer (CGL) is preferably from 0.01 to 2 μm.

### Charge Transport Layer (CTL)

A charge transport layer (CTL) contains a charge transport material (CTM) and a binder resin. Other materials may be contained therein as an additive, such as an antioxidant.

There are usable charge transport materials (CTM), including, for example, a triphenylamine derivative, a hydrazone compound, a styryl compound, a benzyl compound and a butadiene compound. Such a charge transport material is dissolved in an appropriate solvent to form the layer.

Examples of a resin used for a charge transport layer (CTL) include polystyrene, acryl resin, methacryl resin, vinyl chloride resin, vinyl acetate resin, polyvinyl butyral resin, epoxy resin, phenol resin, polyester resin, alkyl resin, polycarbonate resin, silicone resin, melamine resin and copolymeric resin having at least two repeating units of these resins. In addition to these insulating resins, there may be usable a polymeric organic semiconductor, such as poly-N-vinyl carbazole.

A binder used for a charge transport layer (CTL) preferably is a polycarbonate resin. A polycarbonate resin is preferable for enhancement of dispersibility of a charge transport material (CTM) and electrophotographic characteristics. The ratio of charge transport material (CTM) to binder resin is preferably from 10 to 200 parts by mass of a charge transport material to 100 parts by mass of a binder.

### Antioxidant

Application of an antioxidant to a constituent layer of a photoreceptor minimizes effects of actinic gases such as NOₓ, inhibiting occurrence of image troubles under an environment of high temperature and high humidity.

A typical antioxidant used in the invention is a substance with a property preventing or inhibiting an action of oxygen under light, heat or discharge to an auto-oxidative material existing on the photoreceptor surface, as detailed in the following compounds.

### (1) Radical Chain Transfer Inhibitor:

Examples include a phenol type antioxidant, a hindered phenol type antioxidant, an amine type antioxidant, a hindered amine type antioxidant, a diallyldiamine type antioxidant, a diallylamine type antioxidant and a hydroquinone type antioxidant.

### (2) Peroxide Decomposable Compound:

Examples include a sulfur antioxidant, thio-ethers, a phosphoric antioxidant and a phosphorous antioxidant.

The hindered phenol type antioxidant (antioxidant having a hindered phenol structure) is a compound having a bulky organic group at an ortho-position to a phenolic OH group or an alkoxylated phenolic OH group, and the hindered amine type antioxidant (an antioxidant having a hindered amine structure) is a compound having a bulky organic group in the vicinity of a N-atoms. A bulky organic group includes a branched alkyl group and, for example, is preferably t-butyl group.

Of the foregoing antioxidants, a radical chain transfer inhibitor, as described in (1) are preferred, and of these, an antioxidant having a hindered phenol structure or a hindered amine structure is preferred, which inhibits the reaction of oxygen with radical active species generated from a polymerization initiator and causes the radical active species to effectively contribute to polymerization.

Two or more antioxidants may be used in combination and, for example, a hindered phenol antioxidant (1) and a thio-ether antioxidant may be used in combination.

In one preferred embodiment of the invention, an antioxidant having the foregoing hindered amine structure in the molecule is effective in enhancement of image quality, such as prevention of image non-sharpness or black spotting. In another embodiment, an antioxidant having a hindered phenol structure and a hindered amine structure in the molecule is also preferred.

### Protective Layer

A protective layer is formed by coating a coating composition prepared by addition of inorganic particles to a binder resin on a charge transport layer. The protective layer preferably contains an antioxidant and a lubricant.

There are usable inorganic fine particles such as silica, alumina, strontium titanate, zinc oxide, titanium oxide, tin oxide, antimony oxide, indium oxide, bismuth oxide, tin-doped indium oxide, antimony- or tantalum-doped tin oxide or zirconium oxide. Of these, silica, alumina, titanium oxide or strontium titanate is preferred.

The number average primary particle size of inorganic particles is preferably from 1 nm to 300 nm, and more preferably from 5 nm to 100 nm. The number average primary particle size of inorganic particles is a value obtained in such a manner that 300 particles are randomly chosen and observed with a transmission electron microscope at a 10,000-fold magnification and the number average diameter of the Fere diameter is calculated from the observed values.

A binder resin used for a protective layer may employ any one of a thermoplastic resin and a thermosetting resin. Specific examples thereof include a polyvinyl butyral resin, an epoxy resin, a polyurethane resin, a phenol resin, a polyester resin, an alkyd resin, a polycarbonate resin, a silicone resin, and a melamine resin.

Examples of a lubricant material used for a protective layer include resin fine-powder (e.g., fluororesin, polyolefin resin, silicone resin, melamine resin, urea resin, acryl resin, styrene resin, and the like), metal oxide fine-powder (e.g., titanium oxide, aluminum oxide, tin oxide, and the like), a solid lubricant (e.g., polytetrafluoroethylene, polychlorotrifluoroethylene, polyfluorovinylidene, zinc stearate, aluminum stearate, and the like), silicone oil (e.g., dimethylsilicone oil, methylphenylsilicone oil, methyl hydrogen polysiloxane, cyclic dimethyl polysiloxane, alkyl-modified silicone oil, polyether-modified silicone oil, alcohol-modified silicone oil, fluorine-modified silicone oil, amino-modified silicone oil, mercapto-modified silicone oil, epoxy-modified silicone oil, carboxy-modified silicone oil, higher fatty acid-modified silicone oil, and the like), fluororesin powder (e.g., tetrafluoroethylene resin powder, trifluorochloro ethylene resin powder, hexafluoroethylene propylene powder, fluorinated vinyl resin powder, fluorinated vinylidene resin powder, fluoro-di-chloro-ethylene resin powder and copolymers of these), polyolefin resin powder (e.g., homo-polymer resin powder such as polyethylene resin powder, polypropylene resin powder and polyhexene resin powder; copolymer resin powder such as ethylene-propylene copolymer and ethylene-butene copolymer, three-dimensional copolymer of these and hexane; and heat-modified polyolefin resin powder). Of these, silicone oil is preferred to achieve enhanced reduction of friction coefficient.

The molecular weight or the individual resin or its powdery particle size may appropriately be chosen. In the case of a particulate material, its particle size is preferably from 0.1 μm. A dispersing agent to allow a lubricant to be homogeneously dispersed may be added to a binder resin. The foregoing lubricant material may be added to a charge transport layer in cases when the charge transport layer is the uppermost layer.

### Preparation of Photoreceptor

Preparation of the individual layers of a photoreceptor (intermediate layer, photosensitive layer, charge generation layer, charge transport layer, protective layer) can be conducted by coating a layer by an immersion coating method, a circular quantity-control coating, or their combination, but is not limited to these. The immerse coating and circular quantity-control coating are detailed in JP A 2006-7155 and JP A S58-189061, respectively.

There will now be specifically described the constitution of an abrasive tape as an abrasive member.

### Substrate of Abrasive Tape

A backing support usable in the invention may be any one which can achieve secure adhesion to a binder resin to form a solid body containing adhesive grains and also exhibit flexibility, and flexible members known in the art, typified by resin film are usable. Specifically, sheet-moldable resin materials known in the art are cited and examples thereof include a polyester resin such as polyethylene terephthalate, a polyamide resin such as nylon film, a cellulose resin such triacetate cellulose film, a polyurethane resin and an epoxy resin. Of these, the polyethylene terephthalate film is specifically preferred, various kinds of which are commercially readily available and can be chosen.

### Abrasive Grain

Abrasive grains, which are contained in an abrasive tape of a solid body, essentially perform abrasion of the surface of the photosensitive layer of a photoreceptor. Any abrasive grains which can form groves capable of holding an external additive or a lubricant in an amount not causing an image trouble the initial stage of image formation are usable and are not limited with respect to material quality, grain size or form.

Specific examples of a material usable as an abrasive grain include aluminum oxide, diamond, chromium oxide, silicon carbide, iron oxide, cerium oxide, corundum, silicon nitride, molybdenum carbide, tungsten carbide and silicon oxide. Of these, diamond is preferred.

### Binder Resin

Any resin in which abrasive grains can be uniformly dispersed may be used for a binder resin and is not specifically limited, and there are usable a thermoplastic resin, thermosetting resin, a reaction type resin, an electron beam-curable resin, an ultraviolet ray-curable resin, a visible light-curable resin and the like. Examples of a thermoplastic resin include a vinyl resin such as an acryl resin or styrene-butadiene copolymer resin; and a condensation type resin such as a polyamide resin, polyester resin, polycarbonate resin, polyurethane elastomer resin, or polyamide-silicone resin. Examples of a thermosetting resin include a phenol resin, phenoxy-resin, polyurethane resin, polyester resin, silicone resin, melamine resin and alkyd resin.

### Adhesive

To achieve strong adhesion between a substrate and the binder resin is cited a ultraviolet ray-curable adhesive known in the art, such as polyethylene-acrylic acid copolymer.

### Masking Parts

Masking parts are those having transmitting of UV light and heat resistance, whose example includes glass.

### EXAMPLES

The present invention will be further described with reference to examples but is by no means limited to these. In Examples, “part(s)” represents part(s) by mass, unless otherwise noted.

### Example 1

Preparation of Photoreceptor

### Preparation of Conductive Substrate:

An electrically conductive aluminum substrate with a 30 mm diameter and a 360 mm length was prepared and the surface of the conductive substrate was subjected to a machining treatment so that the conductive substrate surface exhibited a ten-point mean surface roughness (R_{z}). The ten-point mean surface roughness (R_{z}) is a value determined in accordance with JIS B 0601-2001 or ISO 468-1982.

### Formation of Intermediate Layer

A dispersion having the following composition was diluted two times with the same solvent mixture as below, allowed to stand over 24 hours, and then filtered with a filter (RIGIMESH 5 μm filter, made by Nippon Pall Co.) to prepare a coating composition of an intermediate layer.

| | | |
|---|---|---|
| Polyamide resin CM 8000 (made by TORAY) | 1 | part |
| Titanium oxide SMT 500SAS (made by | 3 | parts |
| TAYCA Co.) | | |
| Methanol | 8 | parts |
| 1-Butanol | 2 | parts |

Using a sand mill as a dispersing machine, the mixture was batch-wise dispersed over 10 hours to prepare a coating composition.

The thus prepared coating composition was coated on the substrate described above by an immersion coating method to form a 2 μm thick dry layer.

### Formation of Charge Generation Layer

Preparation of coating composition of Charge generation Layer
Charge generation material:

| | |
|---|---|
| Titanyl phthalocyanine pigment* | 20 parts |
| Polyvinyl butyral resin (#6000-C, made by Denki | 10 parts |
| Kagaku Kogyo Co. Ltd.) | |
| t-Butyl acetate | 700 parts |
| 4-Methox-4-methyl-2-pentanone | 300 parts |

*Titanyl phthalocyanine exhibiting a maximum refraction peak at least at a position of 27.3 ± 0.2° in CU-Kα characteristic X-ray refraction spectrum.

The foregoing composition was dispersed over 10 hours in a sand mill to prepare a coating composition of a charge generation layer.

The coating composition was coated on the foregoing intermediate layer by an immersion coating method to form a charge generation layer of a 0.3 μm dry thickness.

### Formation of Charge Transport Layer

Preparation of coating composition of Charge Transport Layer

| | |
|---|---|
| Charge transport material [4,4′-dimethyl-4″-(β- | 25 parts |
| phenylstyryl)triphenylamine] | |
| Binder: polycarbonate (Z300, made | 300 parts |
| by Mitsubishi Gas Chemical Company INC.) | |
| Antioxidant (IRGANOX 1010, supplied by | 6 parts |
| Nippon Ciba-Geigy Co.) | |
| THF | 1600 parts |
| Toluene | 400 parts |
| Silicone oil (KF-50, made by | 0.001 parts |
| Shin-Etsu Kagaku Co.) | |

The foregoing composition was dispersed to prepare a coating composition of a charge transport layer.

The coating composition was coated on the charge generation layer by an immersion coating method, and was dried for 70 minutes at 110° C. to form a charge transport layer of a 25 μm dry thickness.

### Formation of Protective Layer

Preparation of coating composition of Protective Layer

| | |
|---|---|
| Particulate titanium oxide (SMT 100 SAS, | 0.6 parts |
| made by TAYCA Co.) | |
| 1-Propanol | 5 parts |

The foregoing composition was mixed and dispersed by a Ultrasonic homogenizer over 1 hour to obtain a dispersion. Then, 1.5 parts of radical-polymerizable compound composed of acryl compounds A and B (mass ratio A/B=1/1) and 0.07 parts of a polymerization initiator (IRGACURE 184, supplied by Ciba Japan Co., Ltd.) were dissolved in the dispersion to prepare a coating composition of a protective layer.

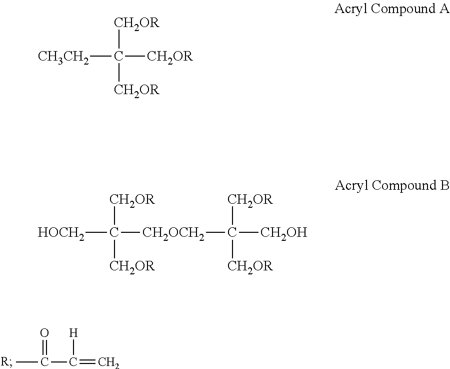

The protective layer coating composition was coated on the overall surface of the charge transport layer by the immersion coating method to form a 2.0 μm thickness after being cured. After coating, a coated layer was exposed to ultraviolet rays using a mercury lamp exposure device (ECS-401GX, made by EYE GRAPHICS CO., LTD.) at an integrated amount of light of 25 J/cm² in a UV illumination photometer UVPF-A1 (PD-365), made by EYE GRAPHICS CO., LTD.

### Abrading Protective Layer of Photoreceptor

Photoreceptors having roughened surface 1-a through 1-g, each having different surface roughness shown in Table 1 were obtained by abrading the surface of the protective layer of prepared photoreceptor by employing the abrading apparatus shown in FIG. 4. Surface roughness Rz was controlled by varying the pressing extent of the abrasion tape.

The surface roughness (Rz) is a value determined by using a laser microscope (VK-9510, made by KEYENCE Corp.).

TABLE 1

| Photoreceptor having | Surface | |
|---|---|---|
| roughened surface | roughness Rz | Pressing extent of |
| No. | (μm) | abrasive tape (mm) |
| 1-a | 0.0080 | 0.08 |
| 1-b | 0.010 | 0.1 |
| 1-c | 0.050 | 0.2 |
| 1-d | 0.10 | 0.4 |
| 1-e | 0.30 | 0.5 |
| 1-f | 0.50 | 0.7 |
| 1-g | 0.70 | 1.0 |

### Preparation of Photoreceptor No. 1-a

Abrasive tape was prepared by employing 3M™ Diamond Lapping Film 661X having the same width as a backup roll and 45 m length as the abrasive material. Abrading was conducted by abrading apparatus shown in FIG. 4 with the following conditions.

### Abrading Condition

Width of a backup roll: 100 mm
Hardness of backup roll: 30°
Rotational speed of photoreceptor: 450 rpm
Feed per stroke of abrasive tape: 2 cm/min
Moving speed of photoreceptor: 20.0 cm/min
Hardness designates value measured by ASKER RUBBER HARDNESS METER MODEL C, manufactured by Kobunshi Keiki Co., Ltd.

### Preparation of Photoreceptor No. 1-b

Photoreceptor No. 1-b was prepared in the same way as Photoreceptor No. 1-a, except that pressing extent of abrasive tape was 0.1 mm and obtained surface roughness Rz of 0.01 μm as shown in Table 1.

### Preparation of Photoreceptor No. 1-c

Photoreceptor No. 1-c was prepared in the same way as Photoreceptor No. 1-a, except that pressing extent of abrasive tape was 0.2 mm and obtained surface roughness Rz of 0.05 μm as shown in Table 1.

### Preparation of Photoreceptor No. 1-d

Photoreceptor No. 1-d was prepared in the same way as Photoreceptor No. 1-a, except that pressing extent of abrasive tape was 0.4 mm and obtained surface roughness Rz of 0.10 μm as shown in Table 1.

### Preparation of Photoreceptor No. 1-e

Photoreceptor No. 1-e was prepared in the same way as Photoreceptor No. 1-a, except that pressing extent of abrasive tape was 0.5 mm and obtained surface roughness Rz of 0.30 μm as shown in Table 1.

### Preparation of Photoreceptor No. 1-f

Photoreceptor No. 1-f was prepared in the same way as Photoreceptor No. 1-a, except that pressing extent of abrasive tape was 0.7 mm and obtained surface roughness Rz of 0.50 μm as shown in Table 1.

### Preparation of Photoreceptor No. 1-g

Photoreceptor No. 1-g was prepared in the same way as Photoreceptor No. 1-a, except that pressing extent of abrasive tape was 1.0 mm and obtained surface roughness Rz of 0.70 μm as shown in Table 1.

### Preparation of Mask

Mask was prepared by employing colorless transparent soda glass having a thickness of 300 μm as a substrate, and the mask has density of laser light non-transmitting region of 9 per 10 μm square, distance between neighboring laser light non-transmitting regions of 1.3 μm, shape of the laser light non-transmitting region being circle and area of the laser light non-transmitting region being 3.14 μm² so as to form the shape composed of higher portions and lower portions on a protective layer parallel to rotation axis of the photoreceptor as shown in FIG. 2a.

### (Forming the Shape Composed of Higher Portions and Lower Portions)

The mask as prepared was equipped to a light source member of the shape composed of higher portions and lower portions forming apparatus shown by FIG. 7. Each of peripheral surface of the protective layer of the prepared Photoreceptors No. 1-a through 1-g was irradiated by laser light in accordance with the manufacturing flow chart of intermittent radiation method as shown in FIG. 8 with the following conditions, and formed the shape composed of higher portions and lower portions, in which height from the bottom to top surface of the higher portion of 1 μm, density of the higher portions of 9 per 10 μm square, distance between the higher portions of 1.3 μm, and the shape of the higher portion was circular column. Thus Photoreceptors 1-1 through 1-7 having the shape composed of higher portions and lower portions as shown in Table 3 were prepared. Height N, density of the higher portions and distance between the higher portions designate values measured by laser microscope VK-9510 manufactured by KEYENCE Corp.

### Laser Irradiation Condition

Light source: UV-YAG laser
Average output power: 23.0 A
Laser power: 0.28 W
Frequency: 32.0 kHz
Focusing position: Photoreceptor surface
Processing speed: 1,000 mm/sec

After the laser light irradiation, the light source member was moved so that a region which was not irradiated yet and neighboring to the irradiated region of the photoreceptor was irradiated.

### Preparation of Polymerization Toner

Polymerization Toners No. A to F having different volume based median particle diameters shown in Table 2 were prepared by method described below.

TABLE 2

| Polymerization | Volume based median particle diameter |
|---|---|
| Toner No. | (μm) |
| A | 2.0 |
| B | 3.0 |
| C | 5.0 |
| D | 7.0 |
| E | 8.0 |
| F | 9.0 |

Preparation of Polymerization Toner No. A

Sodium n-dodecylsulfate in an amount of 5.0 parts by mass was placed in 110 parts by mass of deionized water and dissolved with stirring to prepare an aqueous surfactant solution. To the aqueous surfactant solution was added gradually 20.0 parts by mass of copper phthalocyanine (C.I. Pigment Blue 15:3, manufactured by Toyo Ink Mfg. Co., Ltd.) and dispersed by using CLEARMIX W-motion CLM-0.8 (produced by M Technique Co.) to obtain cyan colorant microparticle dispersion 1. Colorant microparticle 1 contained in the Colorant microparticle dispersion 1 exhibited a volume-based median particle diameter of 160 nm.

The volume-based median particle diameter was measured by using MICROTRAC UPA-150 (produced by HONEYWELL Corp.) under the following condition:

### Conditions

Sample refraction index: 1.59

Sample specific gravity: 1.05 (equivalent converted to spherical particle)

Solvent refraction index: 1.33

Solvent viscosity: 0.797 mPa·S (30° C.), 1.002 mPa·S (20° C.)

Zero-point adjustment: adjustment by adding deionized water to a measurement cell.

### Preparation of Resin Particles (1)

Resin Particles (1) having multiple layer structure was prepared by the first, second and third stage polymerization described below.

### (a) First Stage Polymerization

Placed in a vessel fitted with a stirrer, a temperature sensor, a cooling pipe, and a nitrogen introducing device was a surface active agent solution prepared by dissolving 4 parts by mass of the anionic surface active agent represented by following Formula (1) in 3,040 parts by mass of ion-exchanged water, and surfactant aqueous solution was prepared.

C₁₀H₂₁(OCH₂CH₂)₂SO₃Na Formula (1):

Into the surfactant aqueous solution, polymerization initiator solution prepared by dissolving 10 parts by mass of potassium persulfate (KPS) in 400 parts by mass of ion-exchanged water was added, temperature was raised to 75° C., and monomer mixture composed of the following compounds was dripped to the reaction vessel taking one hour.

| | |
|---|---|
| Styrene | 532 parts by mass |
| n-Butyl acrylate | 200 parts by mass |
| Methacrylic acid | 68 parts by mass |
| n-Octylmercaptan | 16.4 parts by mass |

After the monomer mixture was dripped, the first stage polymerization was conducted by heating and agitating at 75° C. for 2 hours, and Resin Particles (A1) was obtained. The Resin Particles (A1) prepared in the first stage polymerization preparation had volume average molecular weight of 16,500.

### (b) Second Stage Polymerization

Monomer-mixture composed of the following compounds was placed into a flask equipped with an agitation device, then, 93.8 parts by mass of paraffin wax HNP-57″ (product by Nippon Seiro Co., Ltd.) was added, and was dissolved by raising the temperature up to 90° C. Thus monomer solution was prepared.

| | |
|---|---|
| Styrene | 101.1 parts by mass |
| n-Butyl acrylate | 62.2 parts by mass |
| Methacrylic acid | 12.3 parts by mass |
| n-Octylmercaptan | 1.75 parts by mass |

Surfactant aqueous solution was prepared by dissolving 3 parts by mass of above described anionic surfactant in ion-exchanged water of 1,560 parts by mass, temperature was raised to 98° C. Into the surfactant aqueous solution, 32.8 parts by mass (converted into solid substance) of Resin Particles (A1) was added, and, monomer solution containing above described paraffin wax was added. The resulting material was dispersed by employing mechanical homogenizer “CLEARMIX” (produced by M Technique Co.) having a circulation channel for 8 hours. Emulsion particles dispersion liquid containing emulsion particles having dispersion particle diameter of 340 nm was prepared.

Then, polymerization initiator solution prepared by dissolving 6 parts by mass of potassium persulfate in 200 parts by mass of ion-exchanged water was added to above described emulsion particles dispersion liquid, Resin Particles (A2) was prepared by conducting polymerization (the second stage polymerization) in which the resulting material was subjected to agitation with heating at 98° C. for 12 hours. Volume average molecular weight of Resin Particles (A2) prepared by the second stage polymerization was 23,000.

### (c) Third Stage Polymerization

Polymerization initiator solution prepared by dissolving 5.45 parts by mass of potassium persulfate in 220 parts by mass of ion-exchanged water was added to Resin Particles (A2) obtained by the second stage polymerization, and monomer-mixture liquid composed of the following composition was dripped for 1 hour at 80° C. to it.

| | |
|---|---|
| Styrene | 293.8 parts by mass |
| n-Butyl acrylate | 154.1 parts by mass |
| n-Octylmercaptan | 7.08 parts by mass |

After completion of addition, polymerization (the third stage polymerization) was conducted by agitation with heating for 2 hours. Resin Particles (1) was prepared by cooling down to 28° C. after polymerization reaction. Resin Particles (1) prepared by the third stage polymerization had volume average molecular weight of 26,800.

### Association Process

Polymerization Toner No. A was manufactured by the following procedure.

### Preparation of Colored Particles (1)

Into a reaction vessel equipped with agitation device, temperature sensor, a condenser tube, a nitrogen introducing device,

| | |
|---|---|
| resin Particles (1) (converted to solid substance), | 400 parts by mass |
| ion-exchanged water | 900 parts by mass |
| Colorant microparticle 1 (converted to solid substance) | 8.0 parts by mass |

were introduced and were agitated. Temperature inside of the reaction vessel was adjusted at 30° C., and pH was controlled between 8 and 11 by adding 5 mol/L of aqueous solution of sodium hydroxide.

Then, aqueous solution prepared by dissolving 2 parts by mass of magnesium chloride hexa hydrate in 1,000 parts by mass of ion-exchanged water was added thereto at 30° C. with agitation taking 10 minutes. Heating-up was started after 3 minutes kept standing, the temperature was raised up to 65° C. taking 60 minutes, whereby association of the particles was conducted. In this state, particle diameter of the association particles was measured by employing “MULTISIZER 3” (product by Beckman Coulter Inc.), aqueous solution prepared by dissolving 40.2 parts by mass of sodium chloride in ion-exchanged water 500 parts by mass was added to terminate the association when the volume based median diameter of the association particles reaches 2.1 μm.

After termination of association fusion was continued by ripening treatment wherein agitation with heating was conducted at liquid temperature of 70° C. for 3 hour.

It was cooled to 30° C. at a rate of 8° C./minutes, produced colored particles were filtrated, rinsed with ion-exchanged water at 45° C. repeatedly, dried by warm air at 40° C. Thus Colored Particles (1) was prepared.

An external additive described below was added to 100 parts by mass of the prepared Colored Particles (1) and external additive treatment was conducted via Henschel Mixer so that Toner (1) was prepared.

External Additive

| | |
|---|---|
| Silica treated by hexamethyl silazane (number average | 0.6 parts by mass |
| primary particle diameter of 12 nm) | |
| Titanium dioxide treated by n-octyl silane (number | 0.8 parts by mass |
| average primary particle diameter of 24 nm) | |

External additive treatment via Henschel Mixer was conducted in a condition of circumferential speed of agitation blade at 35 m/sec, processing temperature at 35° C., and processing time for 15 minutes.

Particle diameter of the association particles was measured by employing “MULTISIZER 3” (product by Beckman Coulter Inc.), to find 2.0 μm. This was designated Polymerization Toner A.

Preparation of Polymerization Toner No. B

Polymerization Toner No. B was prepared in he same manner as Polymerization Toner No. A, except that aqueous solution prepared by dissolving 40.2 parts by mass of sodium chloride in ion-exchanged water 500 parts by mass was added to terminate the association when the volume based median diameter of the association particles reaches 3.1 μm, and the association particles having particle diameter of 3.0 μm were obtained.

Preparation of Polymerization Toner No. C

Polymerization Toner No. C was prepared in he same manner as Polymerization Toner No. A, except that aqueous solution prepared by dissolving 40.2 parts by mass of sodium chloride in ion-exchanged water 500 parts by mass was added to terminate the association when the volume based median diameter of the association particles reaches 5.2 μm, and the association particles having particle diameter of 5.0 μm were obtained.

Preparation of Polymerization Toner No. D

Polymerization Toner No. D was prepared in he same manner as Polymerization Toner No. A, except that aqueous solution prepared by dissolving 40.2 parts by mass of sodium chloride in ion-exchanged water 500 parts by mass was added to terminate the association when the volume based median diameter of the association particles reaches 6.2 μm, and the association particles having particle diameter of 6.0 μm were obtained.

Preparation of Polymerization Toner No. E

Polymerization Toner No. E was prepared in he same manner as Polymerization Toner No. A, except that aqueous solution prepared by dissolving 40.2 parts by mass of sodium chloride in ion-exchanged water 500 parts by mass was added to terminate the association when the volume based median diameter of the association particles reaches 7.2 μm, and the association particles having particle diameter of 7.0 μm were obtained.

Preparation of Polymerization Toner No. C

Polymerization Toner No. C was prepared in he same manner as Polymerization Toner No. A, except that aqueous solution prepared by dissolving 40.2 parts by mass of sodium chloride in ion-exchanged water 500 parts by mass was added to terminate the association when the volume based median diameter of the association particles reaches 8.2 μm, and the association particles having particle diameter of 8.0 μm were obtained.

Test samples No. 101 through 122 were prepared employing a modified composite apparatus “bizhub C352” (product by Konica Minolta Business Technologies, Inc.) in which Photoreceptors No. 1-1 through 1-7 as prepared were installed, in combination with Toner Nos. A through F having different volume based median diameter as described in Table 3. Twenty thousands sheets of A4 size image including a half tone image having image density of 0.4, a line image having 5% pixel and an image having 25% was printed 20,000 sheets at normal temperature and normal humidity (20° C. and 50% RH) for each printer.

### Evaluation

As for samples No. 101 through 122, image quality of image unevenness and thickening line image, and slipping performance of the blade of cleaning performance and blade adhesion were evaluated in a manners described below and the result evaluated by the criteria is shown in Table 3.

### Evaluation of Image Unevenness

Among 20,000 sheets, 10,000th and 20,000th prints were picked out and image quality was evaluated by visual observation of existence of image unevenness.

Image unevenness is an image having image density difference copied from an original having same image density as a whole.

### Evaluation of Image Unevenness

Image density was measured on a half tone image prepared to have same image density as a whole via Macbeth densitometer manufactured by Gretag Macbeth GMB, and the difference between the maximum density and minimum density was calculated. Adhered toner substance due to cleaning defect was removed from the evaluation.

### Evaluation Rank of Image Unevenness

A: Difference between the maximum density and minimum density is not more than 0.05
B: Difference between the maximum density and minimum density is 0.05 to not more than 0.2
C: Difference between the maximum density and minimum density is more than 0.2

### Evaluation of Thickening Line Image

Lines having width of 0.5 mm in the obtained image was observed via optical microscope, and existence of lines having 10% or more increased width was observed.

### Evaluation of Blade Adhesion

Blade was kept contacted to the photoreceptor for 24 hours at temperature of 10° C. and humidity of 20% RH, and difference of torque before and after keeping was measured. Torque was measured by Digital Torque Gauge MD31TGE-10CNT.

### Evaluation Rank of Blade Adhesion

A: Not more than 1.0 kg/f

B: 1.0 kg/f to not more than 1.5 kg/f

C: 1.5 kg/f or more

### Evaluation of Cleaning Deficiency

Existence of toner adhesion to the photoreceptor was visually observed after cleaning of the photoreceptor by the blade.

TABLE 3

| | Photoreceptor | Photoreceptor | | | | | | |
|---|---|---|---|---|---|---|---|---|
| | having | having shape of | | Image | | | | |
| | roughened | higher portions | Polymerization | Unevenness | | | | |
| Sample | surface | and lower | Toner | 10,000th | 20,000th | Line width | Cleaning | Blade |
| No. | No. | portions No.. | No. | print | print | increasing | performance | adhesion |
| 101 | 1-a | 1-1 | C | C | C | No | No | C |
| 102 | 1-b | 1-2 | C | B | A | No | No | B |
| 103 | 1-c | 1-3 | C | A | A | No | No | A |
| 104 | 1-d | 1-4 | C | A | A | No | No | A |
| 105 | 1-e | 1-5 | C | A | A | No | No | A |
| 106 | 1-f | 1-6 | C | A | A | No | No | A |
| 107 | 1-g | 1-7 | C | C | C | No | No | A |
| 108 | 1-b | 1-2 | A | B | A | No | Observed | B |
| 109 | 1-b | 1-2 | B | B | A | No | No | B |
| 110 | 1-b | 1-2 | D | B | A | No | No | B |
| 111 | 1-b | 1-2 | E | A | A | No | No | A |
| 112 | 1-b | 1-2 | F | A | A | Observed | No | B |
| 113 | 1-d | 1-4 | A | A | A | No | Observed | A |
| 114 | 1-d | 1-4 | B | A | A | No | No | A |
| 115 | 1-d | 1-4 | D | A | A | No | No | A |
| 116 | 1-d | 1-4 | E | A | A | No | No | A |
| 117 | 1-d | 1-4 | F | A | A | Observed | No | A |
| 118 | 1-f | 1-6 | A | A | A | No | Observed | A |
| 119 | 1-f | 1-6 | B | A | A | No | No | A |
| 120 | 1-f | 1-6 | D | A | A | No | No | A |
| 121 | 1-f | 1-6 | E | A | A | No | No | A |
| 122 | 1-f | 1-6 | F | A | A | Observed | No | A |

Samples No.102 to 106, 109 to 111, 114 to 116 and 119 to 121 prepared by employing photoreceptors having the shape composed of higher portions and lower portions and surface roughness Rz of the top surface of higher portions of 0.01 μm to 0.5 μm in combination with polymerization toner having volume based median diameter of 3 μm to 8 μm were confirmed to obtain stable image quality without image unevenness, blade adhesion, cleaning deficiency and increasing of fine line width.

Sample No.101 prepared by employing photoreceptor having the shape composed of higher portions and lower portions and surface roughness Rz of the top surface of higher portions of 0.008 μm which is fallen outside of scope of the present invention, in combination with polymerization toner having volume based median diameter of 3 μm to 8 μm, which is fallen within scope of the present invention displayed the result inferior in image unevenness and blade adhesion.

Sample No.107 prepared by employing photoreceptor having the shape composed of higher portions and lower portions and surface roughness Rz of the top surface of higher portions of 0.70 μm, which is fallen outside of the scope of the present invention, in combination with polymerization toner having volume based median diameter of 5.0 μm which is fallen within scope of the present invention displayed the result inferior in image unevenness.

Sample No.108 prepared by employing photoreceptor having the shape composed of higher portions and lower portions and surface roughness Rz of the top surface of higher portions of 0.01 μm which is fallen within the scope of the present invention, in combination with polymerization toner having volume based median diameter of 2.0 μm which is fallen outside of scope of the present invention displayed the result of cleaning deficiency and inferior in image unevenness and blade adhesion to certain degree.

Sample No.112 prepared by employing photoreceptor having the shape composed of higher portions and lower portions and surface roughness Rz of the top surface of higher portions of 0.01 μm which is fallen within the scope of the present invention, in combination with polymerization toner having volume based median diameter of 9.0 μm which is fallen outside of scope of the present invention displayed the result showing line width increasing and to certain degree inferior in blade adhesion.

Sample No.113 prepared by employing photoreceptor having the shape composed of higher portions and lower portions and surface roughness Rz of the top surface of higher portions of 0.10 μm which is fallen within the scope of the present invention, in combination with polymerization toner having volume based median diameter of 2.0 μm which is fallen outside of scope of the present invention displayed the result of cleaning deficiency.

Sample No.117 prepared by employing photoreceptor having the shape composed of higher portions and lower portions and surface roughness Rz of the top surface of higher portions of 0.10 μm which is fallen within the scope of the present invention, in combination with polymerization toner having volume based median diameter of 9.0 μm which is fallen outside of scope of the present invention displayed the result showing line width increasing.

Sample No.118 prepared by employing photoreceptor having the shape composed of higher portions and lower portions and surface roughness Rz of the top surface of higher portions of 0.50 μm which is fallen within the scope of the present invention, in combination with polymerization toner having volume based median diameter of 2.0 μm which is fallen outside of scope of the present invention displayed the result of cleaning deficiency.

Sample No.122 prepared by employing photoreceptor having the shape composed of higher portions and lower portions and surface roughness Rz of the top surface of higher portions of 0.50 μm which is fallen within the scope of the present invention, in combination with polymerization toner having volume based median diameter of 9.0 μm which is fallen outside of scope of the present invention displayed the result showing line width increasing.

### Example 2

### Preparation of Photoreceptor

The same photoreceptor as prepared in Example 1 was prepared.

Preparation of Photoreceptor having Abraded Surface

The same photoreceptor as Photoreceptor having roughened surface No. 1-d prepared in Example 1 was prepared.

### Preparation of Mask

The same mask as prepared in Example 1 was prepared.

### (Forming the Shape Composed of Higher Portions and Lower Portions)

The mask as prepared was equipped to a light source member of the shape composed of higher portions and lower portions forming apparatus shown by FIG. 7. Peripheral surface of the protective layer of the prepared Photoreceptor was irradiated by laser light in accordance with the manufacturing flow chart of intermittent radiation method as shown in FIG. 8 with the following conditions, and formed the shape composed of higher portions and lower portions, so as to have height M from the bottom to top surface of the higher portion as shown in Table 4 and obtained the Photoreceptors No. 2-1 to 2-9 having the shape composed of higher portions and lower portions. Height M was changed by varying the output power among the laser light irradiation conditions. Density of the higher portions was 9 per 10 μm square, distance between neighboring higher portions was 1.3 μm, and the shape of the higher portion was circular column. Thus Photoreceptors 1-1 through 1-7 having the shape composed of higher portions and lower portions as shown in Table 3 were prepared. Height M, density of the higher portions and distance between the neighboring higher portions were the values measured in the same way as Example 1.

### Laser Irradiation Condition

Light source: YAG laser
Average output power: 23.0 A
Laser power: 0.28 W
Frequency: 32.0 kHz
Focusing position: Photoreceptor surface
Processing speed: 1,000 mm/sec

After the laser light irradiation, the light source member was moved so that a region which was not irradiated yet and neighboring to the irradiated region of the photoreceptor was irradiated.

### Preparation of Polymerization Toner

The same polymerization toner as Polymerization Toners No. D prepared in Example 1 having volume based median diameter of 7.0 μm was prepared in the same manner.

Photoreceptors No. 2-1 through 2-9 as prepared were installed in a modified composite apparatus “bizhub C352” (product by Konica Minolta Business Technologies, Inc.), and polymerization toner having volume based median diameter of 7.0 μm was employed. Twenty thousands sheets of A4 size image including a half tone image having image density of 0.4, a line image having 5% pixel and an image having 25% was printed 20,000 sheets at normal temperature and normal humidity (20° C. and 50% RH), and test samples No. 201 through 209 were printed.

### Evaluation

As for samples No. 201 through 209, image unevenness, blade adhesion, cleaning deficiency and increasing of fine line width were evaluated in the same manners as Example 1. The result evaluated by the same criteria as Example 1 is shown in Table 4.

TABLE 4

| | Photoreceptor | | | | | | | |
|---|---|---|---|---|---|---|---|---|
| | having shape of | | Volume based | Image | | | | |
| | higher portions | Height M of | median diameter of | Unevenness | | | | |
| Sample | and lower | higher portion | Polymerization Toner | 10,000th | 20,000th | Blade | Cleaning | Increasing of |
| No. | portions No. | (μm) | (μm) | print | print | adhesion | deficiency | fine line width |
| 201 | 2-1 | 0.6 | 7.0 | A | A | B | No | No |
| 202 | 2-2 | 0.7 | 7.0 | A | A | B | No | No |
| 203 | 2-3 | 0.8 | 7.0 | A | A | A | No | No |
| 204 | 2-4 | 1.0 | 7.0 | A | A | A | No | No |
| 205 | 2-5 | 1.5 | 7.0 | A | A | A | No | No |
| 206 | 2-6 | 2.0 | 7.0 | A | A | A | No | No |
| 207 | 2-7 | 2.2 | 7.0 | A | A | A | No | No |
| 208 | 2-8 | 2.3 | 7.0 | A | A | A | No | No |
| 209 | 2-9 | 2.5 | 7.0 | B | A | A | No | No |

Samples No.203 to 207 employing photoreceptors satisfying a condition of ( 1/10)D≦M≦(⅓)D were confirmed to obtain stable image quality without image unevenness, blade adhesion, cleaning deficiency and increasing of fine line width, wherein M is the height of higher portions of the shape composed of higher portions and lower portions formed on the surface of the protective layer of the photoreceptor. The advantage of the invention was confirmed.

### Example 3

### Preparation of Photoreceptor

The same photoreceptor as prepared in Example 1 was prepared.

Preparation of Photoreceptor having Abraded Surface

The same photoreceptor as Photoreceptor having roughened surface No. 1-d prepared in Example 1 was prepared.

### Preparation of Mask

Masks No. 3-a to 3-I were prepared by employing the same glass having as used in Example 1, and the mask density of laser light non-transmitting region per 10 μm square were varied as shown in Table 5, shape of the laser light non-transmitting region being circle so as to form the shape composed of higher portions and lower portions on a protective layer parallel to rotation axis of the photoreceptor as shown in FIG. 2a.

TABLE 5

| | Density of laser light non- | Distance between |
|---|---|---|
| Mask | transmitting region per 10 μm | neighboring laser |
| No. | square | light non-transmitting regions (μm) |
| 3-a | 1 | 5 |
| 3-b | 10 | 1.3 |
| 3-c | 50 | 0.9 |
| 3-d | 100 | 0.7 |
| 3-e | 500 | 0.5 |
| 3-f | 1,000 | 0.3 |
| 3-g | 3,000 | 0.14 |
| 3-h | 5,000 | 0.1 |
| 3-i | 6,000 | 0.08 |

### (Forming the Shape Composed of Higher Portions and Lower Portions)

Each mask as prepared was equipped to a light source member of the shape composed of higher portions and lower portions forming apparatus shown by FIG. 7. Each of peripheral surface of the protective layer of the prepared Photoreceptor was irradiated by laser light in accordance with the manufacturing flow chart of intermittent radiation method as shown in FIG. 8 with the following conditions, and formed the shape composed of higher portions and lower portions, having different density of the higher portions, thus Photoreceptors 3-1 through 3-9 having the shape composed of higher portions and lower portions as shown in Table 6.

The height from the bottom to top surface of the higher portion was 1 μm, the shape of the higher portion was circular column. Height M, density of the higher portions and distance between neighboring higher portions were the values measured in the same way as Example 1.

### Laser Irradiation Condition

Light source: YAG laser
Average output power: 23.0 A
Laser power: 0.28 W
Frequency: 32.0 kHz
Focusing position: Photoreceptor surface
Processing speed: 1,000 mm/sec

After the laser light irradiation, the light source member was moved so that a region which was not irradiated yet and neighboring to the irradiated region of the photoreceptor was irradiated.

### Preparation of Polymerization Toner

The same polymerization toner as Polymerization Toners No. D prepared in Example 1 having volume based median diameter of 7.0 μm was prepared in the same manner.

Photoreceptors No. 3-1 through 3-9 as prepared were installed in a modified composite apparatus “bizhub C352” (product by Konica Minolta Business Technologies, Inc.), and polymerization toner having volume based median diameter of 7.0 μm was employed. Twenty thousands sheets of A4 size image including a half tone image having image density of 0.4, a line image having 5% pixel and an image having 25% was printed 20,000 sheets at normal temperature and normal humidity (20° C. and 50% RH), and test samples No. 301 through 309 were printed.

### Evaluation

As for samples No. 301 through 309, image unevenness, blade adhesion, cleaning deficiency and increasing of fine line width were evaluated in the same manners as Example 1. The result evaluated by the same criteria as Example 1 is shown in Table 6.

TABLE 6

| | Photoreceptor | | Distance | | | | | |
|---|---|---|---|---|---|---|---|---|
| | irregular shape | | between | | | | | |
| | having higher | Density of the | neighboring | Image | | | | |
| | portions and | higher portions | higher | Unevenness | | | | Increasing |
| Sample | lower portions | per 10 μm | portions | 10,000th | 20,000th | Image | Cleaning | of fine line |
| No. | No. | square | (μm) | print | print | Unevenness | deficiency | width |
| 301 | 3-1 | 1 | 5 | A | A | A | No | No |
| 302 | 3-2 | 10 | 1.3 | A | A | A | No | No |
| 303 | 3-3 | 50 | 0.9 | A | A | A | No | No |
| 304 | 3-4 | 100 | 0.7 | A | A | A | No | No |
| 305 | 3-5 | 500 | 0.5 | A | A | A | No | No |
| 306 | 3-6 | 1000 | 0.3 | A | A | A | No | No |
| 307 | 3-7 | 3000 | 0.14 | A | A | A | No | No |
| 308 | 3-8 | 5000 | 0.1 | A | A | A | No | No |
| 309 | 3-9 | 6000 | 0.08 | B | B | B | No | No |

Samples No.301 to 308 employing photoreceptors having the shape composed of higher portions and lower portions in which surface roughness Rz of the top surface of higher portions is0.10 μm, density of higher portions is 1 to 5,000 per 10 μm square and height from the bottom of higher portions is 1 μm and distance between the neighboring higher portions, in combination with polymerization toner having volume based median diameter of 7 μm were confirmed to obtain stable image quality without image unevenness, blade adhesion, cleaning deficiency and increasing of fine line width. The advantage of the invention was confirmed.

1. An image forming method comprising steps of forming latent image on a photoreceptor and developing the latent image by a developer containing a polymerization toner, wherein the photoreceptor comprises a photosensitive layer provided on a surface of a cylindrical electroconductive substrate, a surface of the photoreceptor has a shape composed of plural lower portions and plural higher portions, a surface roughness of a top surface of the higher portions is 0.01 to 0.5 μm, and a volume based median particle diameter of the polymerization toner is 3 to 8 μm.

2. The image forming method of claim 1, wherein height M of the higher portions from a bottom of the lower portions satisfies relation of ( 1/10)D≦M≦(⅓)D, wherein D is the volume based median particle diameter of the polymerization toner.

3. The image forming method of claim 1, wherein density of the higher portions is 1 to 5,000 per 10 μm square.

4. The image forming method of claim 1, wherein an area of the higher portion at the bottom is 0.008 to 90 μm².

5. The image forming method of claim 4, wherein an area of the higher portion at the bottom is 0.01 to 50 μm².

6. The image forming method of claim 1, wherein height from bottom to top surface of the higher portions is 0.6 to 2.5 μm.

7. The image forming method of claim 6, wherein height from bottom to top surface of the higher portions is 0.8 to 2.2 μm.

8. The image forming method of claim 1, wherein surface roughness Rz of top surface of the higher portions is 0.1 to 0.3 μm.

9. The image forming method of claim 1, wherein the photoreceptor has a protective layer.

10. The image forming method of claim 1, wherein an average circularity of the polymerized toner particles is 0.930 to 1.000,
wherein the circularity is defined by a formula of,
Circularity=((circumference of a circle having the same projective area as a particle image)/(circumference of the projective area of the particle).

11. The image forming method of claim 10, wherein an average circularity of the polymerized toner particles is 0.950 to 0.995.

12. The image forming method of claim 1, wherein a distance between neighboring higher portions is 4 to 7 μm.
